(19) United States
(12) Patent Application Publication
(10) Pub. No.: US 2017/0006639 A1
(43) Pub. Date: Jan. 5, 2017

(54) BASE STATION, COMMUNICATION SYSTEM, AND PROCESSING METHOD PERFORMED BY BASE STATION

(71) Applicant: FUJITSU LIMITED, Kawasaki-shi (JP)

(72) Inventor: Masatsugu Shimizu, Yokohama (JP)

(73) Assignee: FUJITSU LIMITED, Kawasaki-shi (JP)

(21) Appl. No.: 15/155,114

(22) Filed: May 16, 2016

(30) Foreign Application Priority Data
Jun. 30, 2015 (JP) 2015-131507

(51) Int. Cl. H04W 74/08; H04W 72/04

(52) U.S. Cl. CPC H04W 74/0833; H04W 72/0453

(57) ABSTRACT

A base station includes a preamble detecting unit, a separation channel estimating unit, and a demodulation decoding unit. The preamble detecting unit detects path timing for each path included in a reception signal received after a random access preamble is received in a random access procedure. The separation channel estimating unit specifies a plurality of relational expressions at different sample points. Each of the relational expressions represents the reception signal by using the path timing and the channel for each of the paths. Number of the relational expressions corresponds to at least the number of paths. The separation channel estimating unit specifies the channel for each of the paths based on correlation between the specified relational expressions. The demodulation decoding unit demodulates, for each of the paths, data included in the reception signal by using the channel specified by the separation channel estimating unit.

### CROSS-REFERENCE TO RELATED APPLICATIONS

This application is based upon and claims the benefit of priority of the prior Japanese Patent Application No. 2015-131507, filed on Jun. 30, 2015, the entire contents of which are incorporated herein by reference.

### FIELD

The embodiments discussed herein are related to a base station, a communication system, and a processing method performed by the base station.

### BACKGROUND

In the 3^{rd} Generation Partnership Project (3GPP) that is a standards organization of mobile unit communication systems, communication standard called “Long Term Evolution (LTE)” is designed. In LTE, a “random access procedure” is performed at the time of initial access from a user terminal (hereinafter, sometimes referred to as a “User Equipment (UE)”) to a base station (hereinafter, sometimes referred to as an “eNB”). Hereinafter, a random access is sometimes referred to as an “RA”.

FIG. 1 is a schematic diagram illustrating an example of an RA procedure of a related technology. The RA procedure includes sending and receiving messages (hereinafter, sometimes referred to as an “Msg”) 1 to 4 between the UE and the eNB. Namely, in the RA procedure, first, the UE sends an RA preamble as an Msg 1 to the eNB. In the RA preamble, the identifier (ID) of the RA preamble is included. In the description below, a preamble is sometimes referred to as a “PA” and the identifier of an RA preamble is sometimes referred to as a “PA-ID”. The PA-ID included in the RA preamble is randomly selected by the UE from among different PA-IDs (for example, 64 PA-IDs in LTE) that are previously prepared.

Then, the eNB that has received the RA preamble sends an RA response as an Msg 2 with respect to the RA preamble to the UE. In the RA response, both the PA-ID that is included in the RA preamble and information (hereinafter, sometimes referred to as an “Uplink (UL) grant”) that indicates the uplink resource allocated by the eNB for transmission of an Msg 3 in the uplink are included.

Then, the UE that has received the RA response checks whether the PA-ID selected by the own terminal, i.e., the PA-ID that is sent to the eNB by including the PA-ID in the RA preamble, is included in the received RA response. If the PA-ID selected by the own terminal is included in the received RA response, the UE sends, to the eNB by using the uplink resource indicated by an UL grant, the Msg 3 that includes therein, as data, the identifier by which the own terminal can be uniquely specified, i.e., the inherent identifier of the own terminal. In the description below, the identifier inherent to each UE is sometimes referred to as an “UE-ID”.

Then, the eNB that has received the Msg 3 by using the uplink resource indicated by the UL grant sends Contention Resolution to the UE as an Msg 4. In the Contention Resolution, the UE-ID detected by the eNB from the Msg 3 is included.

Then, the UE that has received the Contention Resolution determines, on the basis of the content of the Contention Resolution, whether an RA has been successful. If the UE-ID of the own terminal is included in the Contention Resolution, the UE determines that the RA has been successful whereas, if the UE-ID of the own terminal is not included in the Contention Resolution, the UE determines that the RA has failed. The UE that has succeeded in the RA can start communication related to user data with the eNB. Related-art examples are described in Japanese Laid-open Patent Publication No. 2003-209879, No. 10-93529, No. 08-237190, and No. 07-66768

FIG. 2 is a schematic diagram used for an explanation of problems. In FIG. 2, as an example, a description will be given of a case in which two user terminals, i.e., an UE #1 and an UE #2, perform the RA with respect to the eNB. Furthermore, FIG. 2 is an example of the RA procedure in the case where both the UE #1 and the UE #2 send the same RA preamble by using the same resource.

At Step S11, the UE #1 randomly selects one of the PA-IDs from among the different PA-IDs that are previously prepared and then sends an RA preamble that includes therein the selected PA-ID to the eNB as the Msg 1. At Step S11, it is assumed that the UE #1 has selected the PA-ID=X.

At Step S13, the UE #2 randomly selects one of the different PA-IDs that are previously prepared and sends an RA preamble that includes therein the selected PA-ID to the eNB as the Msg 1. At Step S13, it is assumed that the UE #2 has selected the PA-ID=X. Namely, it is assumed that the UE #2 has selected the same PA-ID as that selected by the UE #1. Furthermore, it is assumed that the transmission of the RA preamble from the UE #2 is performed by using the same resource as that used to send the RA preamble from the UE #1.

Consequently, in the eNB, the PA-ID of the RA preamble received from the UE #1 at Step S11 and the PA-ID of the RA preamble received from the UE #2 at Step S13 are the same PA-ID=X. Furthermore, the transmission of the RA preamble from the UE #1 and the transmission of the RA preamble from the UE #2 are performed by using the same resource. Consequently, in the eNB, the RA preamble received from the UE #1 comes into collision with the RA preamble received from the UE #2 and the reception of two RA preambles is observed as a plurality number of receptions of the same RA preamble.

Thus, at Step S15, the eNB that has detected the RA preamble that includes therein the PA-ID=X sends an RA response that includes therein the PA-ID=X and the UL grant=resource A as the Msg 2. The uplink resource indicated by the UL grant is defined by the time and the frequency.

At Step S17, because the PA-ID selected by the UE #1, i.e., the PA-ID=X, is included in the received RA response, the UE #1 sends, to the eNB by using the resource A, the Msg 3 in which the UE-ID=111 that is the UE-ID of the UE #1 is included as data.

At Step S19, because the PA-ID selected by the UE #2, i.e., the PA-ID=X, is included in the received RA response, the UE #2 sends, to the eNB by using the resource A, the Msg 3 in which the UE-ID=222 that is the UE-ID of the UE #2 is included as data.

Because both the Msg 3 from the UE #1 and the Msg 3 from the UE #2 are sent by using the resource A, both the Msgs 3 reach the eNB in a temporally overlapped manner. Thus, in the eNB, the Msg 3 from the UE #1 comes into collision with the Msg 3 from the UE #2. In this way, when the Msg 3 from the UE #1 comes into collision with the Msg 3 from the UE #2 in a temporally overlapped manner, the Msg 3 from the UE #2 interferes with the Msg 3 from the UE #1, whereas the Msg 3 from the UE #1 interferes with the Msg 3 from the UE #2. Consequently, in the eNB, when the Msg 3 from the UE #1 and the Msg 3 from the UE #2 are temporally overlapped, the eNB can detect only the Msg 3 from the UE in which a propagation environment is favorable between the UE #1 and the UE #2. For example, if the propagation environment is favorable in the UE #1 and the propagation environment is unfavorable in the UE #2, in the eNB, only the Msg 3 from the UE #1 can be detected and the Msg 3 from the UE #2 is hard to be detected.

Consequently, at Step S21, the eNB detects, between the Msg 3 from the UE #1 and the Msg 3 from the UE #2 both of which are received by the resource A, the UE-ID=111 from the Msg 3 received from the UE #1 in which the propagation environment is favorable. Then, the eNB sends, as the Msg 4, the Contention Resolution that includes therein the detected UE-ID=111.

At Step S23, because the UE-ID=111 that is the UE-ID of the UE #1 is included in the received Contention Resolution, the UE #1 that has received the Contention Resolution determines that the RA has been successful.

In contrast, at Step S25, because the UE-ID=222 that is the UE-ID of the UE #2 is not included in the received Contention Resolution, the UE #2 that has received the Contention Resolution determines that the RA has failed.

Then, at Step S27, when a predetermined time T has elapsed after the transmission of the Msg 3 at Step S19 without receiving the Contention Resolution including the UE-ID=222, the UE #2 reselects the PA-ID and resends an RA preamble. At Step S27, it is assumed that the UE #2 selects the PA-ID=Y. Thus, the RA procedure is again performed on the UE #2.

As described above, in FIG. 2, the RA preamble sent by the UE #1 and the RA preamble sent by the UE #2 are the same. Consequently, if the transmission of the RA preamble from the UE #1 and the transmission of the RA preamble from the UE #2 are performed by using the same resource, in the eNB, the RA preamble from the UE #1 comes into collision with the RA preamble from the UE #2. Then, as the result of the occurrence of the collision of the RA preambles, in the eNB, the Msg 3 from the UE #1 comes into collision with the Msg 3 from the UE #2. Consequently, because RA fails in the UE #2 in which the propagation environment is unfavorable, the RA procedure is repeatedly performed with respect to the UE #2. Due to the repetitions of the RA procedure performed on the UE #2, a processing delay of the RA procedure with respect to the UE #2 occurs and the power consumption of the UE #2 and the eNB is increased.

Here, because the number of PA-IDs of the selection candidates is limited (for example, 64 PA-IDs in LTE), as the number of UEs is increased, the possibility that a collision occurs between RA preambles and the possibility that a collision occurs between the Msgs 3 is increased; therefore, a success rate of the RA is decreased. Consequently, the number of UEs is increased, the possibility that both the processing delay time of the RA procedure and the power consumption of the UE and the eNB are increased.

### SUMMARY

According to an aspect of an embodiment, a base station includes a detecting unit, a specifying unit, and a demodulating unit. The detecting unit detects path timing for each path included in a reception signal that is received after a random access preamble is received in a random access procedure. The specifying unit specifies a plurality of relational expressions at different sample points. Each of the relational expressions represents the reception signal by using the path timing and a channel for each of the paths. Number of the relational expressions corresponds to at least number of the paths. The specifying unit specifies the channel for each of the paths on the basis of correlation between the specified relational expressions. The demodulating unit demodulates, for each of the paths, data included in the reception signal by using the channel specified by the specifying unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating an example of an RA procedure of a related technology;

FIG. 2 is a schematic diagram used for an explanation of problems;

FIG. 3 is a schematic diagram illustrating an example of the configuration of a communication system according to a first embodiment;

FIG. 4 is a block diagram illustrating a configuration example of a base station according to the first embodiment;

FIG. 5 is a schematic diagram exemplifying a model of a reception signal in the time domain;

FIG. 6 is a block diagram illustrating a configuration example of a user terminal according to the first embodiment;

FIG. 7 is a schematic diagram used for an explanation of an operation example of the base station according to the first embodiment;

FIG. 8 is a schematic diagram used for an explanation of an operation example of the base station according to the first embodiment;

FIG. 9 is a schematic diagram used for an explanation of an operation example of the base station according to the first embodiment;

FIG. 10 is a schematic diagram used for an explanation of an operation example of the base station according to the first embodiment;

FIG. 11 is a schematic diagram used for an explanation of an operation example of the base station according to the first embodiment;

FIG. 12 is a schematic diagram used for an explanation of an operation example of the base station according to the first embodiment;

FIG. 13 is a schematic diagram used for an explanation of an operation example of the base station according to the first embodiment;

FIG. 14 is a schematic diagram used for an explanation of an operation example of the base station according to the first embodiment;

FIG. 15 is a flowchart for an explanation of a process example of the base station according to the first embodiment;

FIG. 16 is a schematic diagram illustrating an example of the processing sequence of the communication system according to the first embodiment;

FIG. 17 is a schematic diagram exemplifying a model of a reception signal in the frequency domain;

FIG. 18 is a schematic diagram used for an explanation of another example of channel estimation;

FIG. 19 is a schematic diagram used for an explanation of another example of channel estimation;

FIG. 20 is a schematic diagram illustrating an example of the hardware configuration of the base station; and

FIG. 21 is a schematic diagram illustrating an example of the hardware configuration of the user terminal.

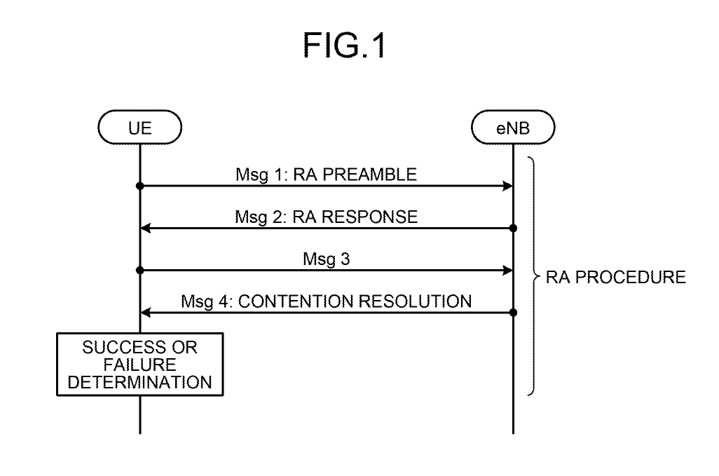

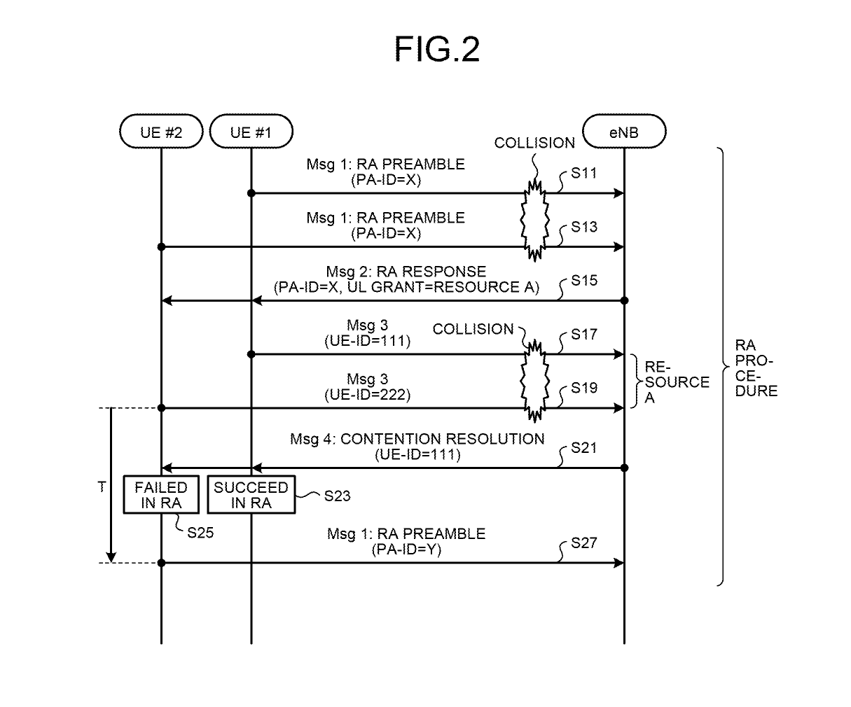

### DESCRIPTION OF EMBODIMENTS

Preferred embodiments of the present invention will be explained with reference to accompanying drawings. Furthermore, the base station, the communication system, and the processing method performed by the base station disclosed in the application are not limited to the embodiment described below. Furthermore, in each of the embodiments described below, components that have the same function and steps in each of which the same process is performed are assigned the same reference numerals; therefore, descriptions of overlapped portions will be omitted.

### [a] First Embodiment

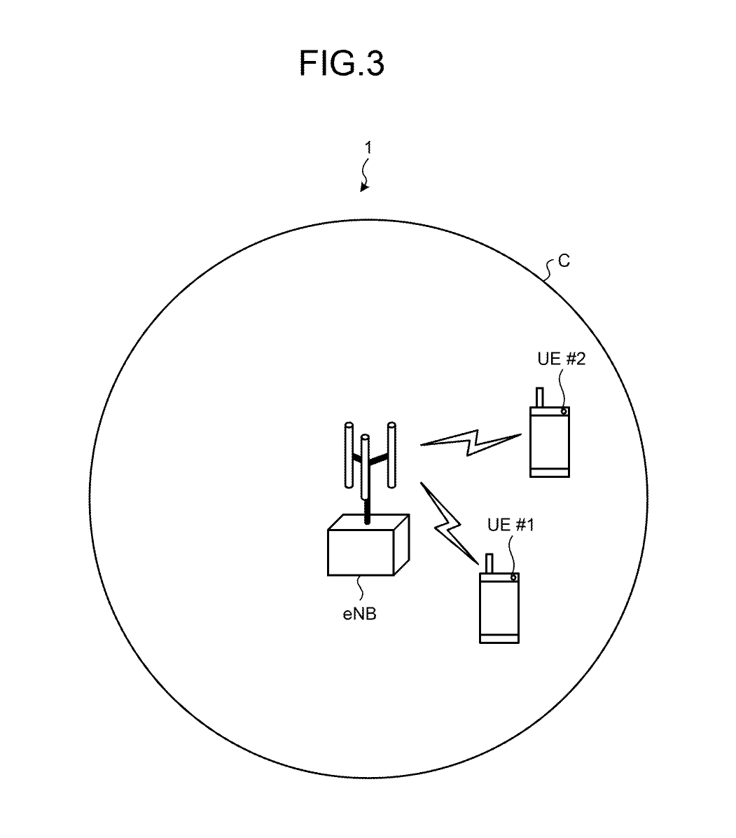

Configuration example of the communication system FIG. 3 is a schematic diagram illustrating an example of the configuration of the communication system according to a first embodiment. In FIG. 3, a communication system 1 includes an eNB, the UE #1, and the UE #2. The UE #1 and the UE #2 are different user terminals. The eNB forms a cell C. The UE #1 and the UE #2 are located in the cell C. An RA procedure is performed when the initial access is performed from each of the UE #1 and the UE #2 to the eNB. Each of the UE #1 and the UE #2 sends, in the RA procedure, an RA preamble as the Msg 1 to the eNB. Furthermore, each of the UE #1 and the UE #2 sends, in the RA procedure, the Msg 3 including the UE-ID to the eNB as data. The eNB sends, in the RA procedure, an RA response as the Msg 2 to the UE #1 and the UE #2. Furthermore, the eNB sends, in the RA procedure, a Contention Resolution as the Msg 4 to the UE #1 and the UE #2. In the description below, when the UE #1 and the UE #2 are not particularly distinguished, the UE #1 and the UE #2 are simply referred to as an UE.

In some cases, a “Cell Radio Network Temporary Identifier (C-RNTI)” may be used to identify each of the UEs in the cell C. The C-RNTI is the identifier dedicated to each of the UEs in the cell C and the number of bits of the C-RNTI is smaller than that of the UE-ID. Furthermore, in the RA procedure, Temporary C-RNTI that is a temporary tentative C-RNTI (hereinafter, sometimes referred to as a “TC-RNTI”) may be used. The TC-RNTI is a tentative C-RNTI that is used only in the RA procedure.

Here, the UE is an example of a communication terminal. Examples of the communication terminal include, in addition to a movable terminal, such as a mobile phone, a smart phone, a tablet-type terminal, or the like, a Machine Type Communication (MTC) terminal, such as a smart meter, or the like.

Configuration Example of the Base Station

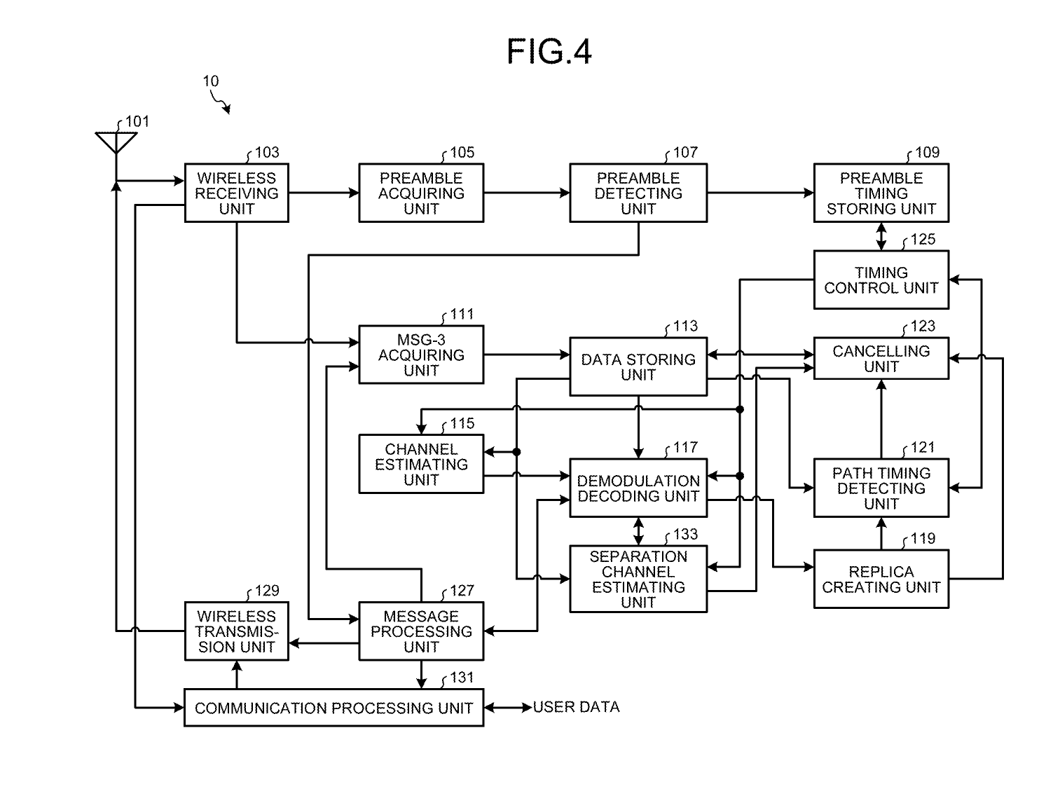

FIG. 4 is a block diagram illustrating a configuration example of the base station according to the first embodiment. A base station 10 illustrated in FIG. 4 corresponds to the eNB illustrated in FIG. 3. The base station 10 includes, for example, as illustrated in FIG. 4, an antenna 101, a wireless receiving unit 103, a preamble acquiring unit 105, a preamble detecting unit 107, a preamble timing storing unit 109, an Msg-3 acquiring unit 111, and a data storing unit 113. Furthermore, the base station 10 includes a channel estimating unit 115, a demodulation decoding unit 117, a replica creating unit 119, a path timing detecting unit 121, a cancelling unit 123, and a timing control unit 125. Furthermore, the base station 10 includes a message processing unit 127, a wireless transmission unit 129, a communication processing unit 131, and a separation channel estimating unit 133.

The wireless receiving unit 103 performs a wireless reception process, such as down conversion, analog-to-digital conversion, and the like, on the signal received from the UE via the antenna 101 and obtains a baseband reception signal. The wireless receiving unit 103 outputs the baseband reception signal to the preamble acquiring unit 105, the Msg-3 acquiring unit 111, and the communication processing unit 131.

The preamble acquiring unit 105 acquires an RA preamble from the baseband reception signal and outputs the acquired RA preamble to the preamble detecting unit 107. The RA preamble includes a single PA-ID out of a plurality of different PA-IDs (for example, 64 PA-IDs in LTE). The plurality of the PA-IDs are associated with a plurality of respective preamble sequences having the same sequence length and the PA-ID is included in the RA preamble as the preamble sequence that is associated with the subject PA-ID. An example of the preamble sequence includes a Zadoff-Chu sequence. The RA preamble is sent as the Msg 1 from the UE in the RA procedure.

The preamble detecting unit 107 detects both the PA-ID included in the RA preamble and a path timing of the RA preamble. In the description below, the path timing of the RA preamble is sometimes referred to as “preamble timing”. Furthermore, the preamble timing is sometimes referred to as “PA timing”. The preamble detecting unit 107 outputs the detected PA-ID to the message processing unit 127 and outputs the PA timing detected for each PA-ID to the preamble timing storing unit 109. The preamble detecting unit 107 calculates each of correlation values between, for example, the RA preamble that is input from the preamble acquiring unit 105 and the known preamble sequences that differ for each PA-ID (for example, 64 preamble sequences in LTE). Then, the preamble detecting unit 107 detects the PA-IDs associated with, for example, the respective preamble sequences, in each of which the correlation value that is equal to or greater than a threshold is obtained, as the PA-IDs included in the RA preamble. Furthermore, the preamble detecting unit 107 detects the timing of the RA preamble, at which, for example, the correlation value equal to or greater than the threshold is obtained from the RA preamble, as the PA timing of the subject RA preamble.

The preamble timing storing unit 109 stores therein the PA timing for each PA-ID.

The Msg-3 acquiring unit 111 acquires the Msg 3 from the baseband reception signal in accordance with the UL grant that is input from the message processing unit 127 and then outputs the acquired Msg 3 to the data storing unit 113. The Msg 3 is an example of data that is sent from the UE in the RA procedure after the RA preamble has been sent.

The data storing unit 113 stores therein both the Msg 3 that is input from the Msg-3 acquiring unit 111 and the data that has been subjected to a cancellation process performed by the cancelling unit 123. In the description below, the Msg 3 that is input from the Msg-3 acquiring unit 111 and the data that has been subjected to the cancellation process performed by the cancelling unit 123 are sometimes collectively referred to as “demodulation target data”.

The channel estimating unit 115 acquires the pilot that is attached to the Msg 3 stored in the data storing unit 113. Then, the channel estimating unit 115 estimates a channel by using the acquired pilot and outputs the estimated channel to the demodulation decoding unit 117. Furthermore, in the Msg 3 stored in the data storing unit 113, there may be a case in which signals that are sent from one or a plurality of UEs and that are received via different paths are included. Thus, the channel estimated by using the pilot that is attached to the Msg 3 acquired from the data storing unit 113 is a combination channel that includes therein channels of the respective paths.

The demodulation decoding unit 117 demodulates the demodulation target data stored in the data storing unit 113 in accordance with the timing control sent from the timing control unit 125. Furthermore, the demodulation decoding unit 117 decodes the demodulated data and outputs the decoded data to both the replica creating unit 119 and the message processing unit 127. The demodulation decoding unit 117 demodulates the demodulation target data by using the channel that is input from the channel estimating unit 115 or by using the channel that is input from the separation channel estimating unit 133. Furthermore, the demodulation decoding unit 117 decodes the demodulation target data by using the TC-RNTI that is input from the message processing unit 127.

The replica creating unit 119 encodes and modulates the data decoded in the demodulation decoding unit 117 and creates a replica of the Msg 3. Then, the replica creating unit 119 outputs the created replica to both the path timing detecting unit 121 and the cancelling unit 123.

The path timing detecting unit 121 detects the path timing (hereinafter, sometimes referred to as “cancel timing”) of the data (hereinafter, sometimes referred to as “cancel data”) that is cancelled from the received Msg 3. The path timing detecting unit 121 detects the cancel timing in accordance with, for example, the timing control sent from the timing control unit 125. The path timing detecting unit 121 outputs the detected cancel timing to the cancelling unit 123 and the timing control unit 125. The path timing detecting unit 121 calculates a correlation value between, for example, the demodulation target data stored in the data storing unit 113 and the replica created by the replica creating unit 119 and detects the timing with the correlation value equal to or greater than the threshold as the cancel timing.

The cancelling unit 123 performs, on the basis of the cancel timing detected by the path timing detecting unit 121, the “cancellation process” that cancels the cancel data from the demodulation target data stored in the data storing unit 113. The cancelling unit 123 creates the cancel data by multiplying the channel estimated by the separation channel estimating unit 133 by, for example, the replica created by the replica creating unit 119. Then, the cancelling unit 123 updates the demodulation target data stored in the data storing unit 113 to the data that has been subjected to the cancellation process.

The timing control unit 125 refers to the PA timing stored in the preamble timing storing unit 109. Furthermore, the timing control unit 125 updates the PA timing stored in the preamble timing storing unit 109 by using the cancel timing that is targeted for the cancellation process. The timing control unit 125 controls the demodulation timing of the demodulation decoding unit 117 on the basis of the PA timing stored in the preamble timing storing unit 109. Furthermore, the timing control unit 125 controls, on the basis of the PA timing stored in the preamble timing storing unit 109, detection timing of the cancel timing obtained by the path timing detecting unit 121. Furthermore, the timing control unit 125 notifies, on the basis of the PA timing stored in the preamble timing storing unit 109, the separation channel estimating unit 133 of the path timing of each of the channels.

The separation channel estimating unit 133 acquires the pilot that is attached to the Msg 3 stored in the data storing unit 113. Then, the separation channel estimating unit 133 estimates a channel for each path from the reception signal on the basis of both the acquired reception signal of the pilot and the path timing for each channel notified from the timing control unit 125.

In the following, an estimation method of a channel will be described. In the RA procedure, when RA preambles each having the same PA-ID are sent from a plurality of UEs by using the same resource, the RA preambles come into collision. For example, when the RA preambles sent from two UEs come into collision, the reception signal yₛ of the Msg 3 received by the base station 10 is represented by, for example, Expression (1) below:

yₛ=h₁s₁+h₂s₂+n (1)

where, hᵢ represents the channel of the i^{th} UE and sᵢ represents the transmission signal from the i^{th} UE. In Expression (1) above, h₁ represents the channel of the UE #1, h₂ represents the channel of the UE #2, s₁ represents the transmission signal from the UE #1, and the s₂ represents the transmission signal from the UE #2. Furthermore, in Expression (1) above, a multipath is omitted.

For example, when reception of the transmission signal s₁ sent from the UE #1 has been successful, if the channel h₁ of the UE #1 is correctly estimated, as indicated by Expression (2) below, it is possible to demodulate the transmission signal s₂ sent from the UE #2 by cancelling the transmission signal s₁ from the reception signal yₛ.

y′ₛ=yₛ−h₁s₁=h₂s₂+n (2)

However, if RA preambles sent from a plurality of UEs come into collision in the RA procedure, because each of the UEs uses the same propagation path estimation signal (pilot signal), for example, as indicated by Expression (3) below, a combination channel obtained by combining each of the channels is estimated from the reception signal yₛ.

$${y}_{p} = {h}_{1} p + {h}_{2} p + n = ( {h}_{1} + {h}_{2} ) p + n \\ {ch}_{est} = {y}_{p} \frac{{p}^{*}}{\vert p {\vert}^{2}} = ( {h}_{1} + {h}_{2} ) p \frac{{p}^{*}}{\vert p {\vert}^{2}} + n \frac{{p}^{*}}{\vert p {\vert}^{2}} = ( {h}_{1} + {h}_{2} ) + {n}^{′} \qquad ( 3 )$$

where, yₚ represents a received pilot signal and p represents a transmitted pilot signal. Furthermore, n and n′ each represent a noise signal, chₑₛₜ represents an estimated combination channel. Furthermore, p* represents the complex conjugate of the pilot signal p.

If a diffusion code used in the Code Division Multiple Access (CDMA) method is used, even if signals of each of the paths are temporally overlapped, channels can be separated and estimated for each path on the basis of the orthogonality of the codes. Furthermore, by using a waveform with high orthogonality for the pilot signal, it is possible to suppress an interference channel. However, for example, with the SC-FDMA method or the like used in the uplink in LTE, as indicated by Expression (3) above, the combination channel chₑₛₜ is estimated. Thus, the separation channel estimating unit 133 estimates a channel for each path. Furthermore, in this application, a description will be given on the basis of LTE specifications; however, the scope of application of the disclosed technology is not limited to LTE.

The separation channel estimating unit 133 acquires the timing of each of the paths included in the reception signal from the timing control unit 125. Then, the separation channel estimating unit 133 represents the reception signal by using the path timing of each of the paths, the replica of the known transmission signal, and the channel (separation channel to be estimated) for each path and calculates a separation channel from the correlation between the sample points the number of which is equal to or greater than the number of detected paths. For example, the separation channel estimating unit 133 specifies, by using the separation channel as a variable, a simultaneous equations including a relational expression that represents the reception signal.

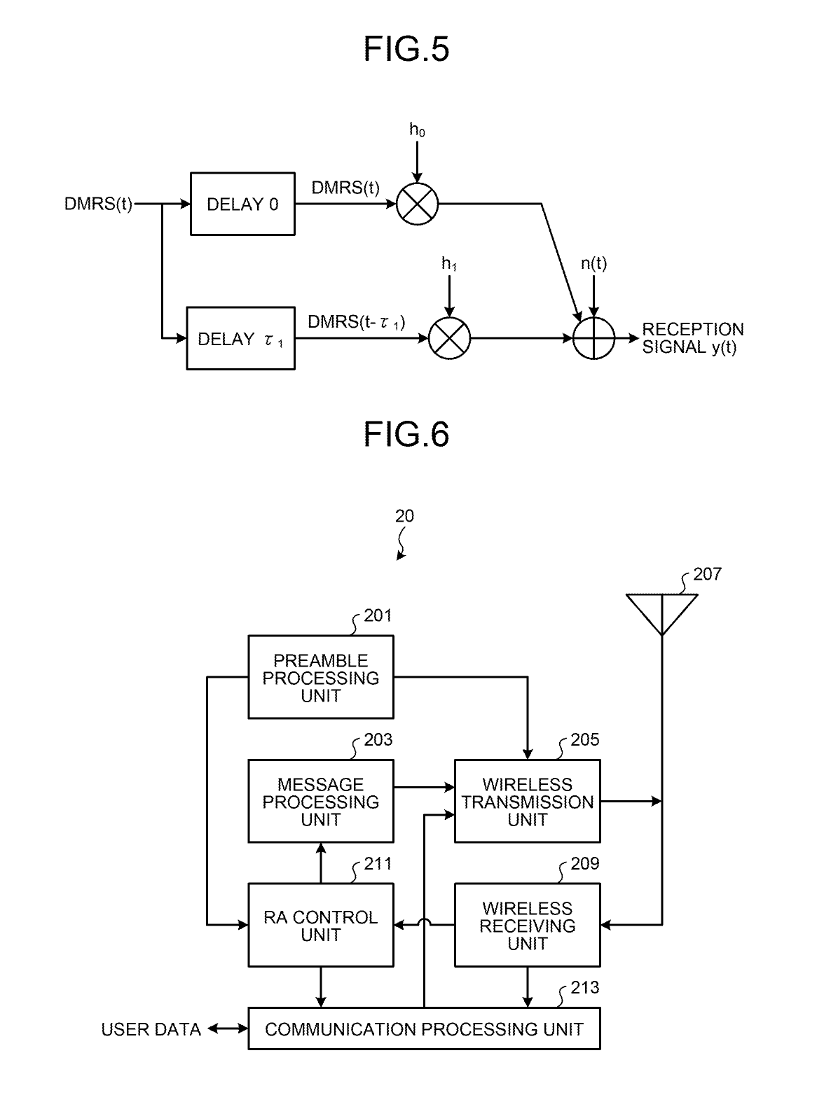

FIG. 5 is a schematic diagram exemplifying a model of a reception signal in the time domain. The reception signal indicated by the model illustrated in FIG. 5 is represented by, for example, Expression (4) below:

$$y ( t ) = {\sum }_{i} {h}_{i} \times {DMRS}_{replica} ( t - {τ}_{i} ) + n ( t ) \qquad ( 4 )$$

In Expression (4) above, y(t) represents a received pilot signal, DMRS_{replica}(t) represents a replica of the pilot signal, hᵢ represents the channel of the i^{th} path, τᵢ represents a delay time (path timing) of the i^{th} path, and n(t) represents noise. The pilot signal is an example of a reference signal.

In the RA procedure, the path timing of each of the paths when the reception of the RA preamble is received is detected by the preamble detecting unit 107. Thus, the delay time τᵢ of each of the paths are already known. Furthermore, because each of the UEs uses the pilot signal specified by the base station 10, the base station 10 is also aware of the pilot signal DMRS_{replica}(t) sent from each of the UEs. Because y(t) is the reception signal, the remaining channels hᵢ become unknown variables. However, because the effect of noise still remains, in the first embodiment, the result obtained by adding a plurality of samples is used. Furthermore, for the plurality of samples, the result of time average may also be used.

If the number of paths is two, the separation channel estimating unit 133 specifies, for example, the plurality of relational expressions represented by (5) below. In Expression (5), the relational expression obtained by using the result of adding the samples in the time period from time t₁ to time t₂ and the relational expression obtained by using the result of adding the samples in the time period from time t₃ to time t₄ are included.

$${\sum }_{t = {t}_{1}}^{{t}_{2}} y ( t ) = {\sum }_{t = {t}_{1}}^{{t}_{2}} {\sum }_{i = 0}^{1} {h}_{i} \times {DMRS}_{replica} ( t - {τ}_{i} ) + n ( t ) ≅ {\sum }_{t = {t}_{1}}^{{t}_{2}} {\sum }_{i = 0}^{1} {h}_{i} \times {DMRS}_{replica} ( t - {τ}_{i} ) \\ {\sum }_{t = {t}_{3}}^{{t}_{4}} y ( t ) = {\sum }_{t = {t}_{3}}^{{t}_{4}} {\sum }_{i = 0}^{1} {h}_{i} \times {DMRS}_{replica} ( t - {τ}_{i} ) + n ( t ) ≅ {\sum }_{t = {t}_{3}}^{{t}_{4}} {\sum }_{i = 0}^{1} {h}_{i} \times {DMRS}_{replica} ( t - {τ}_{i} ) \qquad ( 5 )$$

Expression (5) above is simultaneous equations in which h₀ and h₁ that are the channels of the respective two paths are variables. Furthermore, in Expression (5) above, the plurality of relational expressions in each of which the reception signal y(t) is represented by using the path timing τᵢ and the channel hᵢ for each path is included. Furthermore, in Expression (5) above, the relational expressions the number of which corresponds to at least the number of paths used for obtaining a channel are included. In Expression (5) above, because the number of paths used for obtaining a channel is two, the two relational expressions are included. Furthermore, if relational expressions the number of which corresponds to equal to or greater than the number of paths used for obtaining a channel is included, in Expression (5) above, three or more relational expressions may also be included.

Furthermore, in each of the relational expressions included in Expression (5) above, the reception signal y(t) in the time domain is represented by using the path timing τᵢ for each path, the channel hᵢ for each path, the replica DMRS_{replica}(t) of the pilot signal included in the reception signal y(t). Then, each of the relational expressions included in Expression (5) above is the relational expression specified by different sample points in the time domain.

Furthermore, in Expression (5) above, relational expressions are specified for each different time period, such as the time period from the time t₁ to the time t₂ and the time period from the time t₃ to the time t₄. The left side of Expression (5) above represents the signal obtained by adding the reception signals y(t) at a predetermined number of sample points included in the time period. Furthermore, the right side of Expression (5) above represents the signal obtained by adding the reception signals each of which is represented by the path timing τᵢ for each path, the channel hᵢ for each path, and the replica DMRS_{replica}(t) of the reference signal, which are obtained at the predetermined number of sample points included in the time period. Furthermore, each of the relational expressions included in Expression (5) above may also be averaged by dividing the left side and the right side of Expression (5) by the number of sample points. Furthermore, the sample points in the time period used for each of the relational expressions do not need to be continuous sample points. Furthermore, regarding the time periods for which the sample points that are used for each of the relational expressions, a part of the time periods may also be overlapped each other or the time periods may also be separated each other.

The separation channel estimating unit 133 estimates the channels h₀ and h₁ on the basis of Expression (5) above. Consequently, even if RA preambles sent from a plurality of UEs comes into collision in the RA procedure, the separation channel estimating unit 133 can accurately estimate the channel of the signal sent from each of the UEs. Then, by using the channel estimated for each path, the demodulation decoding unit 117 can accurately demodulate and decode the Msg 3 that is sent from each of the UEs.

The message processing unit 127 creates the Msg 2 and the Msg 4. The message processing unit 127 creates an RA response as the Msg 2 on the basis of the PA-ID detected by the preamble detecting unit 107 and encodes and modulates the created RA response. The message processing unit 127 outputs the modulated RA response to the wireless transmission unit 129. Furthermore, the message processing unit 127 determines the UL grant for the Msg 3, includes the determined UL grant in the RA response, and outputs the RA response to the Msg-3 acquiring unit 111. Furthermore, the message processing unit 127 includes the TC-RNTI that is associated with the determined UL grant in the RA response. Furthermore, the message processing unit 127 creates, on the basis of the data decoded by the demodulation decoding unit 117, the Contention Resolution as the Msg 4, and encodes and modulates the created Contention Resolution. Then, the message processing unit 127 outputs the modulated Contention Resolution to the wireless transmission unit 129. Furthermore, the message processing unit 127 outputs the TC-RNTI that is associated with the determined UL grant to the demodulation decoding unit 117. Furthermore, the message processing unit 127 allocates the C-RNTI to each of the UEs and outputs the allocated C-RNTI to the communication processing unit 131.

The communication processing unit 131 acquires user data from the baseband reception signal, demodulates and decodes the acquired user data by using the C-RNTI, and outputs the decoded user data. Furthermore, the communication processing unit 131 encodes and modulates the user data that is targeted for transmission by using the C-RNTI and outputs the modulated user data to the wireless transmission unit 129.

The wireless transmission unit 129 acquires a wireless signal by performing a wireless transmission process, such as digital-to-analog conversion, up-conversion, and the like, on the modulated RA response, the modulated Contention Resolution, and on the modulated user data. The wireless transmission unit 129 sends the wireless signal via the antenna 101.

Configuration Example of the User Terminal

FIG. 6 is a block diagram illustrating a configuration example of a user terminal according to the first embodiment. A user terminal 20 illustrated in FIG. 6 corresponds to the UE #1 and the UE #2 illustrated in FIG. 3. The user terminal 20 includes, for example, as illustrated in FIG. 6, a preamble processing unit 201, a message processing unit 203, a wireless transmission unit 205, an antenna 207, a wireless receiving unit 209, an RA control unit 211, and a communication processing unit 213.

The preamble processing unit 201 randomly selects a single PA-ID out of the plurality of the previously prepared different PA-IDs (for example, 64 PA-IDs in LTE) and creates an RA preamble that includes therein the selected PA-ID. The plurality of the PA-IDs is associated with each of the plurality of preamble sequences with the same sequence length and the preamble processing unit 201 includes the preamble sequence that is associated with the selected PA-ID in the RA preamble. The preamble processing unit 201 outputs the created RA preamble as the Msg 1 to the wireless transmission unit 205. Furthermore, the preamble processing unit 201 outputs the selected PA-ID to the RA control unit 211.

The message processing unit 203 creates the Msg 3. The message processing unit 203 encodes and modulates, by using the TC-RNTI that is input from the RA control unit 211, the Msg 3 that includes therein the UE-ID. The message processing unit 203 maps the modulated Msg 3 onto the uplink resource indicated by the UL grant that is input from the RA control unit 211 and then outputs the mapped Msg 3 to the wireless transmission unit 205.

The wireless receiving unit 209 performs a wireless reception process, such as down conversion, analog-to-digital conversion, and the like, on the signal received from the base station 10 via the antenna 207 and obtains a baseband reception signal. Then the wireless receiving unit 209 outputs the baseband reception signal to the RA control unit 211 and the communication processing unit 213.

The RA control unit 211 acquires an RA response from the baseband reception signal. In the RA response, the PA-ID, the TC-RNTI, and the UL grant are included. The RA control unit 211 acquires the PA-ID, the TC-RNTI, and the UL grant from the RA response. The RA control unit 211 determines whether the PA-ID that is input from the preamble processing unit 201 matches the PA-ID that is acquired from the RA response. The RA control unit 211 outputs the TC-RNTI and the UL grant acquired from the RA response to the message processing unit 203. Furthermore, the RA control unit 211 acquires the Contention Resolution from the baseband reception signal. In the Contention Resolution, the UE-ID and the C-RNTI are included. The RA control unit 211 acquires the UE-ID and the C-RNTI from the Contention Resolution. The RA control unit 211 determines the success or failure of the RA on the basis of the UE-ID acquired from the Contention Resolution. If the RA control unit 211 determines that the RA has been successful, the RA control unit 211 outputs the C-RNTI acquired from the Contention Resolution to the communication processing unit 213.

The communication processing unit 213 acquires user data from the baseband reception signal, demodulates and decodes the acquired user data by using the C-RNTI, and outputs the decoded user data. Furthermore, the communication processing unit 213 encodes and modulates the user data that is targeted for the transmission by using the C-RNTI and then outputs the modulated user data to the wireless transmission unit 205.

The wireless transmission unit 205 performs a wireless transmission process, such as digital-to-analog conversion, up conversion, and the like, on the RA preamble, the modulated Msg 3, and the modulated user data and then obtains a wireless signal. Then, the wireless transmission unit 205 sends the wireless signal via the antenna 207.

Operation Example of the Base Station and the User Terminal

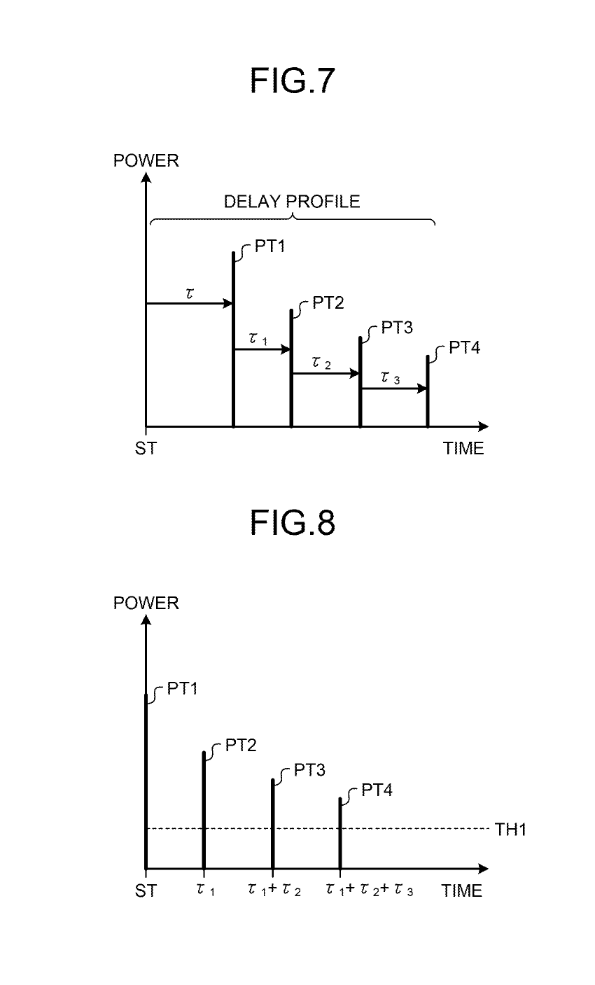

FIGS. 7 to 14 are schematic diagrams each used for an explanation of an operation example of the base station according to the first embodiment. In the following, as an example, a description will be given of a case in which the RA preamble and the Msg 3 that are sent from the UE #1 pass through the two paths and reach the base station 10 and the RA preamble and the Msg 3 that are sent from the UE #2 pass through the two paths, which are different from the paths from the UE #1, and reach the base station 10. The UE #1 and the UE #2 used for the operation example described below corresponds to the user terminal 20 illustrated in FIG. 6.

In the UE #1, the preamble processing unit 201 selects, for example, the PA-ID=X from among the plurality of the previously prepared different PA-IDs and the wireless transmission unit 205 sends the RA preamble that includes therein the PA-ID=X as the Msg 1 to the base station 10. The RA preamble sent from the UE #1 passes through the two different paths, i.e., a path 1 and a path 2, and reaches the base station 10. Furthermore, the preamble processing unit 201 in the UE #1 outputs the PA-ID=X to the RA control unit 211.

In contrast, in the UE #2, the preamble processing unit 201 selects, for example, the PA-ID=X from among the plurality of the previously prepared different PA-IDs and the wireless transmission unit 205 sends the RA preamble that includes therein the PA-ID=X as the Msg 1 to the base station 10. Furthermore, the preamble processing unit 201 in the UE #2 outputs the PA-ID=X to the RA control unit 211. Here, it is assumed that the UE #2 has sent the RA preamble by using the same resource as that used by the UE #1 to send the RA preamble. Namely, it is assumed that both the UE #1 and the UE #2 has sent the same RA preamble by using the same resource. The RA preamble sent from the UE #2 passes through the two different paths, i.e., a path 3 and a path 4, and reaches the base station 10. Namely, the base station 10 receives four RA preambles that are sent from the UE #1 and the UE #2 by using the same resource and that pass through the four different paths, i.e., the path 1, the path 2, the path 3, and the path 4.

The preamble detecting unit 107 detects the PA-ID included in the RA preamble. Because the PA-IDs of the four received RA preambles are all the same indicated by X, the preamble detecting unit 107 detects the PA-ID=X from all of the four RA preambles. Because the PA-IDs that are detected four times are all the same indicated by X, the preamble detecting unit 107 outputs, to the message processing unit 127, the PA-ID=X only one time with respect to the detection performed by four times.

Furthermore, the preamble detecting unit 107 detects, for example, four PA timing of PT1, PT2, PT3, and PT4 illustrated in FIG. 7 and acquires the delay profile illustrated in FIG. 7. The PA timing PT1 is the path timing of the RA preamble that is sent from the UE #1, that passes through the path 1, and that is received by the base station 10. The PA timing PT2 is the path timing of the RA preamble that is sent from the UE #1, that passes through the path 2, and that is received by the base station 10. The PA timing PT3 is the path timing of the RA preamble that is sent from the UE #2, that passes through the path 3, and that is received by the base station 10. The PA timing PT4 is the path timing of the RA preamble that is sent from the UE #2, that passes through the path 4, and that is received by the base station 10. For example, the PA timing PT1 is delayed by τ with respect to the reference timing ST of the base station 10 and the PA timing PT2 is delayed by τ₁ with respect to the PA timing PT1. Furthermore, the PA timing PT3 is delayed by τ₂ with respect to the PA timing PT2 and the PA timing PT4 is delayed by τ₃ with respect to the PA timing PT3.

In this way, in the base station 10, because the PA-ID of the four received RA preambles are all the same indicated by X, the PA timing of PT1, PT2, PT3, and PT4 are observed as the multipath timing of the same RA preambles. Namely, PA timing PT1 corresponds to an advance wave, the PA timing PT2 corresponds to a first delay wave, the PA timing PT3 corresponds to a second delay wave, and the PA timing PT4 corresponds to a third delay wave.

The preamble detecting unit 107 outputs the delay τ to the message processing unit 127. Furthermore, the preamble detecting unit 107 shifts the delay profile illustrated in FIG. 7 by −τ and outputs the shifted delay profile to the preamble timing storing unit 109. By shifting the delay profile illustrated in FIG. 7 by −τ, as illustrated in FIG. 8, the PA timing PT1 matches the reference timing ST of the base station 10. Consequently, in the preamble timing storing unit 109, the pieces of the PA timing of PT1, PT2, PT3, and PT4 illustrated in FIG. 8 are stored. In the preamble timing storing unit 109, the PA timing PT1 is the timing with no delay with respect to the reference timing ST and the PA timing PT2 is the timing with the delay of τ₁ with respect to the reference timing ST. Furthermore, in the preamble timing storing unit 109, the PA timing PT3 is the timing with the delay of τ₁+τ₂ with respect to the reference timing ST and the PA timing PT4 is the timing with the delay of τ₁+τ₂+τ₃ with respect to the reference timing ST.

In this way, the preamble detecting unit 107 detects the PA timing of PT1, PT2, PT3, and PT4 of the plurality of the same RA preambles sent from the UE #1 and the UE #2 in the RA procedure.

Then, when the PA-ID=X and the delay τ are input from the preamble detecting unit 107, the message processing unit 127 determines the UL grant for the Msg 3. The message processing unit 127 determines to set the UL grant to, for example, the resource A. Then, the message processing unit 127 creates an RA response in which the PA-ID=X, the transmission timing correction value τ that is equal to the delay τ, the UL grant=resource A, and the TC-RNTI (for example, TC-RNTI=01) associated with the resource A are included. The created RA response is sent via the antenna 101 by the wireless transmission unit 129 as the Msg 2 in the RA procedure. Furthermore, the message processing unit 127 outputs the determined UL grant=resource A to the Msg-3 acquiring unit 111 and outputs the TC-RNTI=01 to the demodulation decoding unit 117.

Then, the RA control unit 211 in the UE #1 detects that the PA-ID=X that is input from the preamble processing unit 201 matches the PA-ID=X that is acquired from the RA response. Then, the RA control unit 211 in the UE #1 acquires, from the RA response, a transmission timing correction value τ, the UL grant=resource A, and the TC-RNTI=01. Then, the RA control unit 211 in the UE #1 outputs the transmission timing correction value τ, the UL grant=resource A, and the TC-RNTI=01 to the message processing unit 203 and stores the TC-RNTI=01. The message processing unit 203 in the UE #1 creates the Msg 3 in which the UE-ID=111 that is the UE-ID of the UE #1 is included in the data portion. When creating the Msg 3, the message processing unit 203 in the UE #1 attaches, to the data portion in the Msg 3, the Cyclic Redundancy Check (CRC) bits that are masked by the TC-RNTI=01. Then, the message processing unit 203 in the UE #1 encodes the Msg 3 in which the data portion including the UE-ID=111 and the CRC bits that are masked by the TC-RNTI=01 are included. The message processing unit 203 in the UE #1 maps the encoded Msg 3 onto the resource A and advances the transmission timing by τ (i.e., adjusts by −τ). The mapped Msg 3 in which the transmission timing has been adjusted is sent to the base station 10 via the antenna 207 by the wireless transmission unit 205 in the UE #1.

Furthermore, the RA control unit 211 in the UE #2 detects that the PA-ID=X that is input from the preamble processing unit 201 matches the PA-ID=X that is acquired from the RA response. Then, the RA control unit 211 in the UE #2 acquires the transmission timing correction value τ, the UL grant=resource A, and the TC-RNTI=01 from the RA response. Then, the RA control unit 211 in the UE #2 outputs the transmission timing correction value τ, the UL grant=resource A, and the TC-RNTI=01 to the message processing unit 203 and then stores the TC-RNTI=01. The message processing unit 203 in the UE #2 creates the Msg 3 in which the UE-ID=222 that is the UE-ID of the UE #2 is included in the data portion. When creating the Msg 3, the message processing unit 203 in the UE #2 attaches, to the data portion in the Msg 3, the CRC bits that are masked by the TC-RNTI=01. Then, the message processing unit 203 in the UE #2 encodes the Msg 3 in which the data portion including the UE-ID=222 and the CRC bits that are masked by the TC-RNTI=01 are included. The message processing unit 203 in the UE #2 maps the encoded Msg 3 onto the resource A and advances the transmission timing by τ (i.e., adjusts by −τ). The mapped Msg 3 in which the transmission timing has been adjusted is sent to the base station 10 via the antenna 207 by the wireless transmission unit 205 in the UE #2.

Then, the Msg-3 acquiring unit 111 in the base station 10 acquires the Msg 3 in accordance with the UL grant=resource A that was input from the message processing unit 127 and then outputs the acquired Msg 3 to the data storing unit 113.

At this point, because the time period from the transmission of the RA preamble to the transmission of the Msg 3 is short, the Msg 3 is received by the base station 10 by passing through the same path as that used by the RA preamble. Namely, the Msg 3 sent from the UE #1 passes through the two paths, i.e., the path 1 and the path 2, and reaches the base station 10, whereas the Msg 3 sent from the UE #2 passes through the two paths, i.e., the path 3 and the path 4, and reaches the base station 10. Furthermore, both the UE #1 and the UE #2 send the Msgs 3 by using the same resource A. Consequently, the base station 10 receives four Msgs 3 that are sent from the UE #1 and the UE #2 by using the same resource and that pass through the four different paths, i.e., the path 1, the path 2, the path 3, and the path 4.

If the delay of τ₁+τ₂ is less than the time period of the Msg 3, the Msg 3 that passes through the path 1 and the Msg 3 that passes through the path 3 reach the eNB in a temporally overlapped manner. Furthermore, if the delay of τ₁+τ₂+τ₃ is less than the time period of the Msg 3, the Msg 3 that passes through the path 1 and the Msg 3 that passes through the path 4 reach the eNB in a temporally overlapped manner. Furthermore, if the delay of τ₂ is less than the time period of the Msg 3, the Msg 3 that passes through the path 2 and the Msg 3 that passes through the path 3 reach the eNB in a temporally overlapped manner. Furthermore, if the delay of τ₂+τ₃ is less than the time period of the Msg 3, the Msg 3 that passes through the path 2 and the Msg 3 that passes through the path 4 reach the eNB in a temporally overlapped manner. Namely, if one of the delay of τ₂, the delay of τ₁+τ₂, the delay of τ₂+τ₃, and the delay of τ₁+τ₂+τ₃ is less than the time period of the Msg 3, in the base station 10, the Msg 3 sent from the UE #1 comes into collision with the Msg 3 sent from the UE #2. Namely, the Msg 3 sent from the UE #1 and the Msg 3 sent from the UE #2 are included in the Msg 3 received by the wireless receiving unit 103 in the base station 10. The wireless receiving unit 103 outputs, to the Msg-3 acquiring unit 111, the received Msg 3 in which the Msg 3 sent from the UE #1 and the Msg 3 sent from the UE #2 are included.

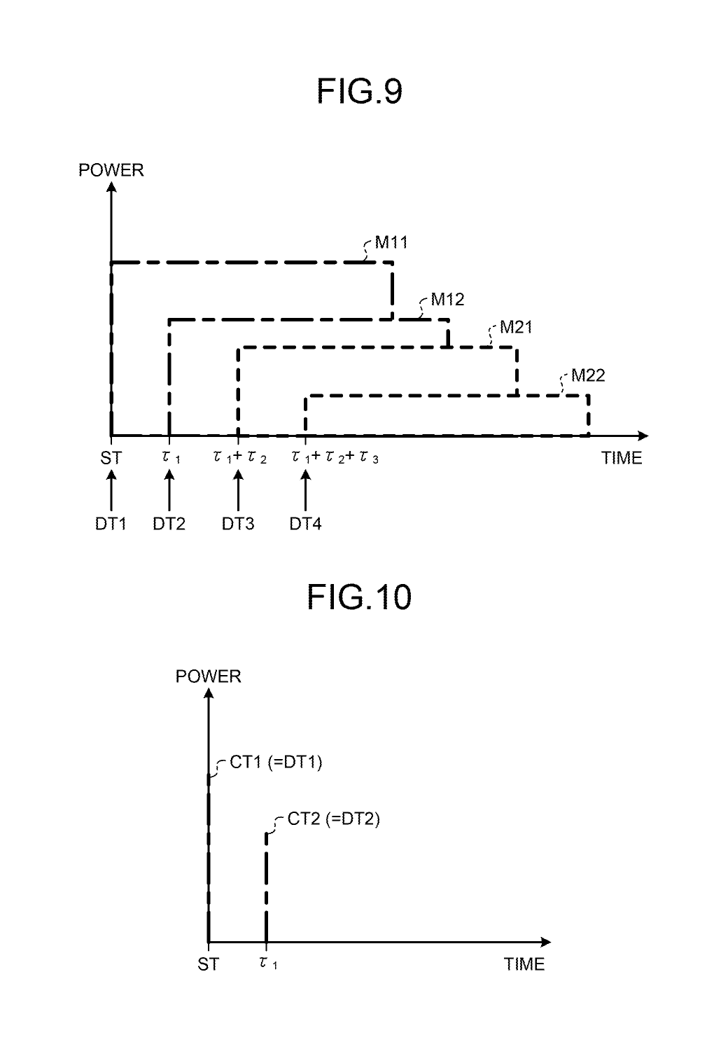

Thus, for example, the state of the Msg 3 acquired by the Msg-3 acquiring unit 111 becomes the state illustrated in FIG. 9. In FIG. 9, a “message M11” is the Msg 3 that is received from the UE #1 by passing through the path 1 and a “message M12” is the Msg 3 that is received from the UE #1 by passing through the path 2. Furthermore, a “message M21” is the Msg 3 that is received from the UE #2 by passing through the path 3 and a “message M22” is the Msg 3 that is received from the UE #2 by passing through the path 4. Thus, the content of the message M11 and the content of the message M12 are the same and the content of the message M21 and the content of the message M22 are the same. Furthermore, the transmission timing of the Msg 3 in the UE #1 and the UE #2 in accordance with the transmission timing correction value τ. Consequently, in the base station 10, as illustrated in FIG. 9, the top timing DT1 of the message M11 (i.e., the path timing of the message M11) matches the reference timing ST of the base station 10. Furthermore, as described above, the Msg 3 is received by the base station 10 by passing through the same path as that through which the RA preamble passes. Consequently, as illustrated in FIG. 9, the top timing DT2 (i.e., the path timing of the message M12) of the message M12 is delayed by τ₁ with respect to the top timing DT1 of the message M11. Furthermore, the top timing DT3 of the message M21 (i.e., the path timing of the message M21) is delayed by τ₂ with respect to the top timing DT2 of the message M12. Furthermore, the top timing DT4 of the message M22 (i.e., the path timing of the message M22) is delayed by τ₃ with respect to the top timing DT3 of the message M21. Consequently, the top timing DT1 matches the PA timing PT1 and the top timing DT2 matches the PA timing PT2. Furthermore, the top timing DT3 matches the PA timing PT3 and the top timing DT4 matches the PA timing PT4. Namely, the top timing of DT1, DT2, DT3, and DT4 (FIG. 9) are associated with the PA timing of PT1, PT2, PT3, and PT4 (FIG. 8), respectively, one to one.

Furthermore, the Msg 3 acquired by the Msg-3 acquiring unit 111 includes therein the message M11, the message M12, the message M21, and the message M22 and these messages come into collision with each other. The Msg 3 that includes therein the messages M11, M12, M21, and M22 is an example of the data that is received after the RA preamble has been received in the RA procedure by the base station 10.

Furthermore, here, as an example, it is assumed that the propagation environment of the path 1 is better than the propagation environment of the path 2, it is assumed that the propagation environment of the path 2 is better than the propagation environment of the path 3, and it is assumed that the propagation environment of the path 3 is better than the propagation environment of the path 4. Thus, the received power of the message M11 is greater than the received power of the message M12 and the received power of the message M12 is greater than the received power of the message M21. Namely, the received power of the message M11 is sufficiently greater than the received power of the messages M21 and M22.

The data storing unit 113 stores therein the Msg 3 that includes therein the messages M11, M12, M21, and M22 as the demodulation target data.

Then, the channel estimating unit 115 estimates, by using the pilot included in the demodulation target data, the channel of the reception signal and outputs the estimated channel to the demodulation decoding unit 117. Furthermore, the channel estimated here is, for example, as described above by using Expression (3), a combination channel in which the channels of each of the paths included in the reception signal are combined. Here, if the propagation environment of one of the paths is favorable and the received power thereof is great, the value of the channel of the subject path is the value that is close to the value of the combination channel. In contrast, if the propagation environment of neither of the paths is favorable and the received power thereof is small, the value of each of the channels is a value that is different from the value of the combination channel.

Then, the timing control unit 125 outputs a demodulation execution instruction at the reference timing ST to the demodulation decoding unit 117. In accordance with the demodulation execution instruction, the demodulation decoding unit 117 sets the reference timing ST to the demodulation timing for the demodulation target data stored in the data storing unit 113, i.e., the demodulation target data (FIG. 9) that includes the messages M11, M12, M21, and M22, and demodulates the demodulation target data. At this point, the demodulation decoding unit 117 demodulates the demodulation target data (FIG. 9) by using the combination channel estimated by the channel estimating unit 115. The message M11 is demodulated by demodulating at the reference timing ST. The demodulation decoding unit 117 decodes the demodulated message M11. The demodulation decoding unit 117 performs the CRC by demasking the CRC bits included in the decoded message M11 by the TC-RNTI=01. Because the CRC bits in the message M11 is masked, as described above, by the TC-RNTI=01 performed by the UE #1, if no error is present in the demodulated message M11 that has been subjected to the error correction, the demodulation decoding unit 117 succeeds in the CRC performed by demasking using the TC-RNTI=01. Thus, the demodulation decoding unit 117 succeeds in the decoding of the message M11 and detects the UE-ID=111 from the data portion in the message M11. The demodulation decoding unit 117 outputs the decoded message M11 to the replica creating unit 119 and outputs the detected UE-ID=111 to the message processing unit 127.

Then, the separation channel estimating unit 133 acquires the demodulation target data from the data storing unit 113. Then, the separation channel estimating unit 133 specifies Expression (5) described above on the basis of the demodulation target data that is the reception signal and the path timing for each channel that is notified from the timing control unit 125. Then, the separation channel estimating unit 133 estimates, on the basis of Expression (5), the channel hᵢ of each of the paths from the demodulation target data. The separation channel estimating unit 133 estimates, by using, for example, the pilot attached to each of the message M11, the message M12, the message M21, and the message M22, the channel h₁ of the path 1, the channel h₂ of the path 2, the channel h₃ of the path 3, and the channel h₄ of the path 4. Then, the separation channel estimating unit 133 outputs the channels h₁, h₂, h₃, and h₄ that are estimated for each of the paths to the cancelling unit 123.

Here, if the propagation environment of the path 1 is favorable and the received power thereof is great, the value of the channel of the path 1 becomes the value close to the value of the combination channel that is estimated by the channel estimating unit 115. Thus, the number of errors in the data for the path 1 demodulated performed by using the combination channel is small; therefore, when the error correction process is executed, the demodulation decoding unit 117 succeeds in the CRC of the demodulated data. In contrast, if the propagation environment of the path 1 is unfavorable and the received power thereof is small, the value of the channel of the path 1 is different from the value of the combination channel estimated by the channel estimating unit 115. Consequently, in the data demodulated by using the combination channel, a large number of errors are included and, even if the error correction process is performed, the demodulation decoding unit 117 fails in the CRC of the demodulated data.

If the demodulation decoding unit 117 fails in the CRC, the demodulation decoding unit 117 instructs the separation channel estimating unit 133 to estimate a channel. The separation channel estimating unit 133 acquires the demodulation target data from the data storing unit 113 and specifies Expression (5) described above on the basis of the demodulation target data that is the reception signal and the path timing for each channel notified from the timing control unit 125. Then, the separation channel estimating unit 133 estimates, from the demodulation target data on the basis of Expression (5), the channel hᵢ of each of the paths. Then, the separation channel estimating unit 133 outputs the estimated channel hᵢ of each of the paths to the demodulation decoding unit 117.

Then, the demodulation decoding unit 117 again performs the decoding and the CRC on the demodulation target data by using the channel hᵢ of each of the paths estimated by the separation channel estimating unit 133 and by using the reference timing ST as the demodulation timing. If the CRC has been successful, the demodulation decoding unit 117 outputs the message M11 in which the decoding is successful to the replica creating unit 119 and outputs the UE-ID=111 that is extracted from the data portion included in the message M11 to the message processing unit 127. Then, the separation channel estimating unit 133 outputs the channel hᵢ of each of the path to the cancelling unit 123.

Then, if the UE-ID=111 is input from the demodulation decoding unit 117, the message processing unit 127 creates Contention Resolution in which the UE-ID=111 and the C-RNTI are included in the data portion. In the process of creating the Contention Resolution, the message processing unit 127 allocates, for example, the C-RNTI=01 to the UE-ID=111. The message processing unit 127 attaches the CRC bits masked by the TC-RNTI=01 to the data portion in the Contention Resolution. Then, the message processing unit 127 encodes the Contention Resolution that includes therein the data portion, in which both the UE-ID=111 and the C-RNTI=01 are included, and the CRC bits that are masked by the TC-RNTI=01. The encoded Contention Resolution is sent as the Msg 4 in the RA procedure via the antenna 101 by the wireless transmission unit 129. Furthermore, the message processing unit 127 outputs the allocated C-RNTI=01 to the communication processing unit 131.

Then, the RA control unit 211 in the UE #1 demodulates and decodes the Contention Resolution. The RA control unit 211 in the UE #1 performs the CRC by demasking the CRC bits that is included in the decoded Contention Resolution by the TC-RNTI=01. Because, as described above, the CRC bits included in the Contention Resolution is demasked by the TC-RNTI=01 performed by the base station 10, the RA control unit 211 in the UE #1 succeeds in the CRC due to the demasking performed by using the TC-RNTI=01. Thus, the RA control unit 211 in the UE #1 succeeds in the decoding of the Contention Resolution and detects the UE-ID=111 and the C-RNTI=01 from the data portion in the Contention Resolution. Because the UE-ID that is acquired from the Contention Resolution matches the UE-ID that is included in the Msg 3 regarding the UE-ID=111, the RA control unit 211 in the UE #1 determines that the RA has been successful. Furthermore, because the RA has been successful, the RA control unit 211 in the UE #1 outputs the C-RNTI=01 included in the Contention Resolution to the communication processing unit 213. Then, the communication processing unit 213 in the UE #1 starts communication of user data by using the C-RNTI=01 with the base station 10.

In contrast, the replica creating unit 119 in the base station 10 creates a replica R11 of the message M11 by encoding and modulating the decoded message M11 and outputs the created replica R11 to the path timing detecting unit 121 and the cancelling unit 123.

Then, the path timing detecting unit 121 calculates correlation value between the demodulation target data stored in the data storing unit 113, i.e., the demodulation target data including the messages M11, M12, M21, and M22 (FIG. 9), and the replica R11. The replica R11 is the replica of the message M11. Furthermore, the content of the message M11 and the content of the message M12 are the same. Thus, the correlation value between the demodulation target data including the messages M11, M12, M21, and M22 (FIG. 9) and the replica R11 is equal to or greater than the threshold at the top timing DT1 of the message M11 and at the top timing DT2 of the message M12. Thus, as illustrated in FIG. 10, the path timing detecting unit 121 detects the top timing DT1 as the cancel timing CT1 and detects the top timing DT2 as the cancel timing CT2. The path timing detecting unit 121 outputs the detected cancel timing of CT1 and CT2 to the cancelling unit 123.

Here, for example, the path timing detecting unit 121 detects the cancel timing in accordance with the timing control performed by the timing control unit 125. For example, the timing control unit 125 outputs, to the path timing detecting unit 121, a correlation value calculation instruction at each of the pieces of the timing, i.e., the four pieces of the PA timing PT1 to PT4 (FIG. 8), stored in the preamble timing storing unit 109. In accordance with the correlation value calculation instruction, the path timing detecting unit 121 calculates a correlation value between the demodulation target data and the replica R11 at each of the pieces of timing, i.e., the four pieces of the PA timing PT1 to PT4.

Furthermore, for example, the timing control unit 125 outputs, to the path timing detecting unit 121, the correlation value calculation instruction at the timing in which the power is equal to or greater than a threshold TH1 from among the four pieces of the PA timing PT1 to PT4 (FIG. 8) stored in the preamble timing storing unit 109. In accordance with the correlation value calculation instruction, the path timing detecting unit 121 calculates a correlation value between the demodulation target data and the replica R11 at only the timing in which the power is equal to or greater than the threshold TH1 from among the four pieces of the PA timing PT1 to PT4.

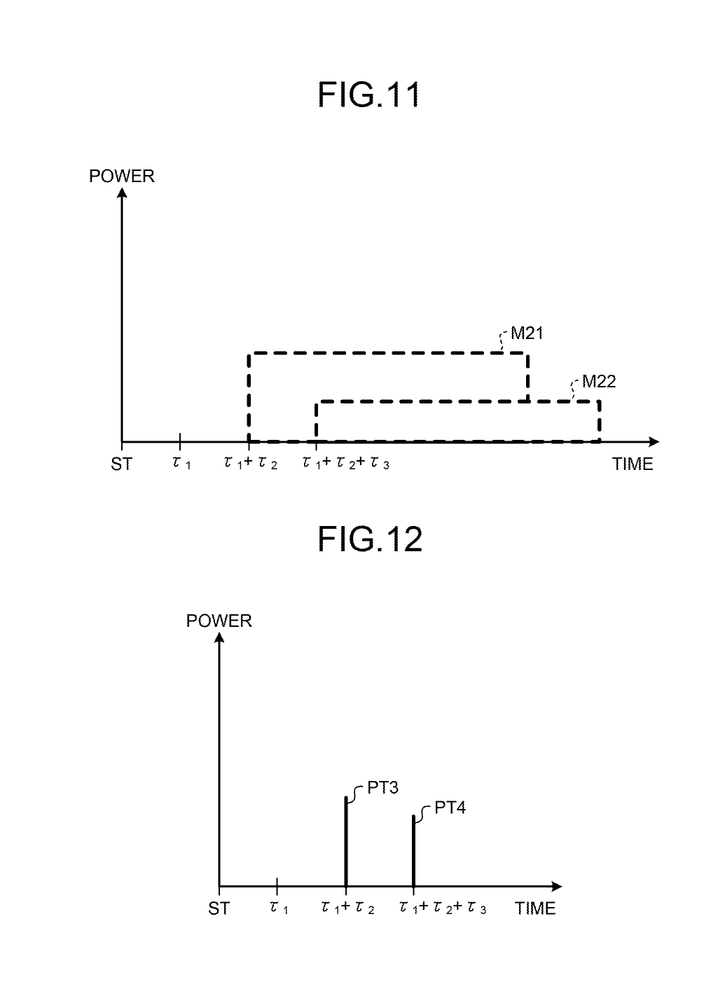

Subsequently, the cancelling unit 123 creates cancel data CD11 by multiplying the channel h₁ that is input from the separation channel estimating unit 133 by the replica R11. Furthermore, the cancelling unit 123 creates cancel data CD12 by multiplying the channel h₂ by the replica R11. Then, the cancelling unit 123 cancels the cancel data CD11 and the cancel data CD12 from the demodulation target data stored in the data storing unit 113, i.e., the demodulation target data including the messages M11, M12, M21, and M22 (FIG. 9). The cancelling unit 123 performs the cancellation process on the cancel data CD11 at the cancel timing CT1 and performs the cancellation process on the cancel data CD12 at the cancel timing CT2. Due to the cancellation process performed by the cancelling unit 123, the messages M11 and M12 are cancelled from the demodulation target data including the messages M11, M12, M21, and M22 (FIG. 9). Thus, in the demodulation target data after the cancellation process performed by the cancelling unit 123, as illustrated in FIG. 11, only the messages M21 and M22 remain. The cancelling unit 123 updates the demodulation target data (FIG. 9) stored in the data storing unit 113 to the demodulation target data subjected to the cancellation process, i.e., to the demodulation target data including the messages M21 and M22 (FIG. 11). Thus, in the subsequent demodulation target data, only the message M21 and the message M22 are included.

The timing control unit 125 updates the PA timing stored in the preamble timing storing unit 109 by using the cancel timing of CT1 and CT2 targeted for the cancellation process. For example, the timing control unit 125 deletes the PA timing associated with the cancel timing of CT1 and CT2 from among the pieces of the PA timing of PT1, PT2, PT3, and PT4. Similarly to the PA timing PT1, the cancel timing CT1 is the timing with no delay with respect to the reference timing ST and, similarly to the PA timing PT2, the cancel timing CT2 is the timing with the delay of τ₁ with respect to the reference timing ST. Namely, the PA timing PT1 is associated with the cancel timing CT1 and the PA timing PT2 is associated with the cancel timing CT2. Thus, the timing control unit 125 deletes the PA timing of PT1 and PT2 from among the pieces of the PA timing of PT1, PT2, PT3, and PT4 stored in the preamble timing storing unit 109. Due to the deletion of the pieces of the PA timing PT1 and PT2, in the preamble timing storing unit 109, as illustrated in FIG. 12, only the pieces of the PA timing of PT3 and PT4 remain.

Then, the timing control unit 125 selects the PA timing PT3 that is the PA timing with the maximum power from among the pieces of the PA timing PT3 and PT4 that remain in the preamble timing storing unit 109. Then, the timing control unit 125 outputs a demodulation execution instruction at the PA timing PT3 to the channel estimating unit 115 and the demodulation decoding unit 117. The channel estimating unit 115 estimates the combination channel by using the pilot that is included in the demodulation target data stored in the data storing unit 113, i.e., the demodulation target data in which the messages M11 and M12 are cancelled (FIG. 11). Then, the channel estimating unit 115 outputs the estimated combination channel to the demodulation decoding unit 117.

In accordance with the demodulation execution instruction sent from the timing control unit 125, the demodulation decoding unit 117 demodulates the demodulation target data (FIG. 11) stored in the data storing unit 113 by setting the PA timing PT3 to the demodulation timing. Namely, the demodulation decoding unit 117 performs the demodulation process by using the PA timing PT3 as the PA timing of the UE #2 that has sent the messages M21 and M22. At this point, the demodulation decoding unit 117 demodulates the demodulation target data by using the combination channel that is input from the channel estimating unit 115. Due to the demodulation at the PA timing PT3, the message M21 is demodulated. The demodulation decoding unit 117 decodes the demodulated message M21. The demodulation decoding unit 117 performs the CRC by demasking the CRC bits included in the decoded message M21 by the TC-RNTI=01. The CRC bits in the message M21 is masked by the TC-RNTI=01 performed by the UE #2. If the CRC is successful, the demodulation decoding unit 117 outputs the decoded message M21 to the replica creating unit 119 and outputs the UE-ID=222 extracted from the data portion in the message M21 to the message processing unit 127.

In contrast, if the CRC has failed, the demodulation decoding unit 117 instructs the separation channel estimating unit 133 to estimate a channel. The separation channel estimating unit 133 acquires the demodulation target data (FIG. 11) from the data storing unit 113 and specifies Expression (5) described above on the basis of the demodulation target data that is the reception signal and the path timing for each channel notified from the timing control unit 125. Then, the separation channel estimating unit 133 estimates the channel hᵢ for each of the paths from the demodulation target data (FIG. 11) on the basis of Expression (5). Then, the separation channel estimating unit 133 outputs the estimated channel hᵢ for each of the paths to the demodulation decoding unit 117. Because the demodulation target data (FIG. 11) including the messages M21 and M22 is stored in the data storing unit 113, the separation channel estimating unit 133 estimates the channel h₃ of the path 3 and the channel h₄ of the path 4 and outputs the estimated channels h₃ and h₄ to the demodulation decoding unit 117.

Then, by using the channel hᵢ for each of the paths estimated by the separation channel estimating unit 133, the demodulation decoding unit 117 again performs the demodulation and the CRC on the demodulation target data by using the PA timing PT3 as the demodulation timing. If the CRC has been successful, the demodulation decoding unit 117 outputs the message M21 in which the decoding has been successful to the replica creating unit 119 and outputs the UE-ID=222 extracted from the data portion in the message M21 to the message processing unit 127. Then, the separation channel estimating unit 133 outputs the channel h₁ for each of the paths to the cancelling unit 123.

Then, if the UE-ID=222 is input from the demodulation decoding unit 117, the message processing unit 127 creates Contention Resolution in which the UE-ID=222 and the C-RNTI are included in the data portion. In the process of creating the Contention Resolution, the message processing unit 127 allocates, for example, the C-RNTI=02 to the UE-ID=222. The message processing unit 127 attaches the CRC bits that is masked by the TC-RNTI=01 to the data portion in the Contention Resolution. Then, the message processing unit 127 encodes the Contention Resolution that includes therein the data portion, in which the UE-ID=222 and the C-RNTI=02 are included, and the CRC bits that are masked by the TC-RNTI=01. The encoded Contention Resolution is sent as the Msg 4 in the RA procedure by the wireless transmission unit 129 via the antenna 101. Furthermore, the message processing unit 127 outputs the allocated C-RNTI=02 to the communication processing unit 131.

The RA control unit 211 in the UE #2 demodulates and decodes the Contention Resolution. The RA control unit 211 in the UE #2 performs the CRC by demasking the CRC bits included in the decoded Contention Resolution by the TC-RNTI=01. Because, as described above, the CRC bits in the Contention Resolution is masked by the base station 10 by the TC-RNTI=01, the RA control unit 211 in the UE #2 succeeds in the CRC performed by the demasking performed by using the TC-RNTI=01. Thus, the RA control unit 211 in the UE #2 succeeds in decoding the Contention Resolution and detects the UE-ID=222 and the C-RNTI=02 from the data portion included in the Contention Resolution. Because the UE-ID that is acquired from the Contention Resolution matches the UE-ID that is included in the Msg 3 regarding the UE-ID=222, the RA control unit 211 in the UE #2 determines that the RA has been successful. Furthermore, because the RA has been successful, the RA control unit 211 in the UE #2 outputs the C-RNTI=02 included in the Contention Resolution to the communication processing unit 213. Then, the communication processing unit 213 in the UE #2 starts the communication of user data with the base station 10 performed by using the C-RNTI=02.

In contrast, the replica creating unit 119 in the base station 10 creates a replica R21 of the message M21 by encoding and modulating the decoded message M21 and outputs the created replica R21 to the path timing detecting unit 121 and the cancelling unit 123.

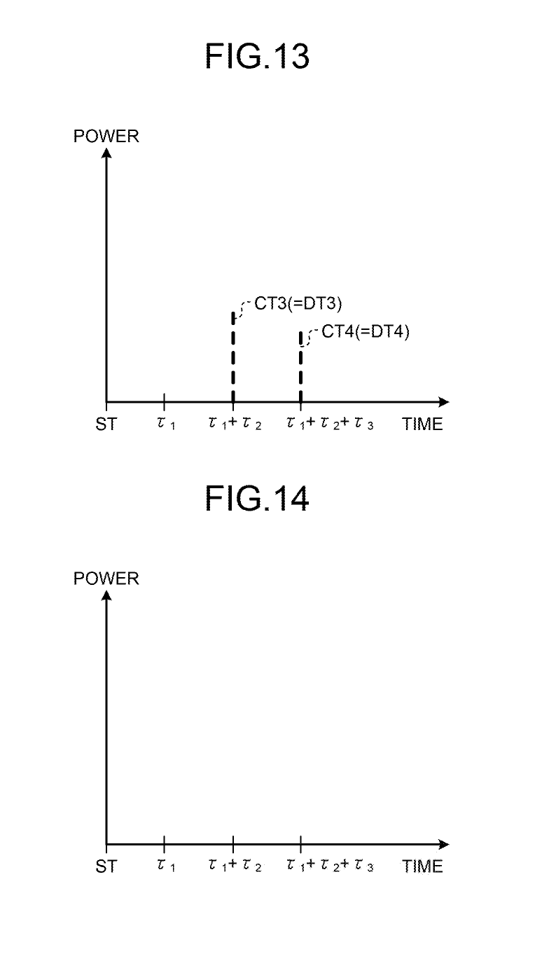

Then, the path timing detecting unit 121 calculates a correlation value between the demodulation target data stored in the data storing unit 113, i.e., the demodulation target data including the messages M21 and M22 (FIG. 11), and the replica R21. The replica R21 is the replica of the message M21. Furthermore, the content of the message M21 and the content of the message M22 are the same. Thus, the correlation value between the demodulation target data including the messages M21 and M22 (FIG. 11) and the replica R21 becomes equal to or greater than the threshold at the top timing DT3 of the message M21 and the top timing DT4 of the message M22. Thus, as illustrated in FIG. 13, the path timing detecting unit 121 detects the top timing DT3 as the cancel timing CT3 and detects the top timing DT4 as the cancel timing CT4. The path timing detecting unit 121 outputs the detected cancel timing of CT3 and CT4 to the cancelling unit 123.

Then, the cancelling unit 123 creates the cancel data CD21 by multiplying the channel h₃ that is input from the separation channel estimating unit 133 by the replica R21. Furthermore, the cancelling unit 123 creates cancel data CD22 by multiplying the channel h₄ that is input from the separation channel estimating unit 133 by the replica R21. Then, the cancelling unit 123 cancels both the cancel data CD21 and the cancel data CD22 from the demodulation target data stored in the data storing unit 113, i.e., the demodulation target data including the messages M21 and M22 (FIG. 11). The cancelling unit 123 performs the cancellation process on the cancel data CD21 at the cancel timing CT3 and performs the cancellation process on the cancel data CD22 at the cancel timing CT4. Consequently, due to the cancellation process performed by the cancelling unit 123, the messages M21 and M22 are cancelled from the demodulation target data including the messages M21 and M22 (FIG. 11) and thus the subsequent demodulation target data is not present. Thus, the cancelling unit 123 deletes the demodulation target data (FIG. 11) stored in the data storing unit 113.

The timing control unit 125 updates the PA timing stored in the preamble timing storing unit 109 by using the cancel timing of CT3 and CT4 targeted for the cancellation process. The cancel timing CT3 is, similarly to the PA timing PT3, the timing with the delay of τ₁+τ₂ with respect to the reference timing ST. Furthermore, the cancel timing CT4 is, similarly to the PA timing PT4, the timing with the delay of τ₁+τ₂+τ₃ with respect to the reference timing ST. Namely, the PA timing PT3 is associated with the cancel timing CT3 and the PA timing PT4 is associated with the cancel timing CT4. Thus, for example, the timing control unit 125 deletes the PA timing PT3 associated with the cancel timing CT3 and the PA timing PT4 associated with the cancel timing CT4. Because the pieces of the PA timing PT3 and PT4 are deleted, the PA timing stored in the preamble timing storing unit 109 disappears, as illustrated in FIG. 14.

Namely, when all of the pieces of the PA timing PT1 to PT4 stored in the preamble timing storing unit 109 are used as the cancel timing, the PA timing stored in the preamble timing storing unit 109 disappears. The cancel timing CT1 matches the top timing DT1 (i.e., the path timing of the message M11) and the cancel timing CT2 matches the top timing DT2 (i.e., the path timing of the message M12). Furthermore, the cancel timing CT3 matches the top timing DT3 (i.e., the path timing of the message M21) and the cancel timing CT4 matches the top timing DT4 (i.e., the path timing of the message M22). Furthermore, as described above, the pieces of the top timing DT1, DT2, DT3, and DT4 (FIG. 9) are associated with, one to one, the pieces of the PA timing PT1, PT2, PT3, and PT4 (FIG. 8), respectively. Thus, when all of the pieces of the PA timing detected by the preamble detecting unit 107 correspond to “first PA timing” or “second PA timing” below, the PA timing stored in the preamble timing storing unit 109 disappears. The “first PA timing” mentioned here is the PA timing that is associated with the path timing of the Msg 3 sent from the UE #1. Furthermore, the “second PA timing” is the PA timing of the UE #2.

Because the PA timing stored in the preamble timing storing unit 109 disappears, the timing control unit 125 outputs an instruction to end the demodulation to the demodulation decoding unit 117. The demodulation decoding unit 117 ends, in accordance with the instruction to end the demodulation, demodulation and decoding of the demodulation target data. Namely, when the PA timing stored in the preamble timing storing unit 109 disappears, the demodulation decoding unit 117 ends demodulation and decoding of the demodulation target data. Because there is no output from the demodulation decoding unit 117 due to the end of the demodulation and the decoding performed by the demodulation decoding unit 117, the creation of a replica performed by the replica creating unit 119, the detection of the cancel timing performed by the path timing detecting unit 121, and the cancellation process performed by the cancelling unit 123 are also ended.

Process Example of the Base Station

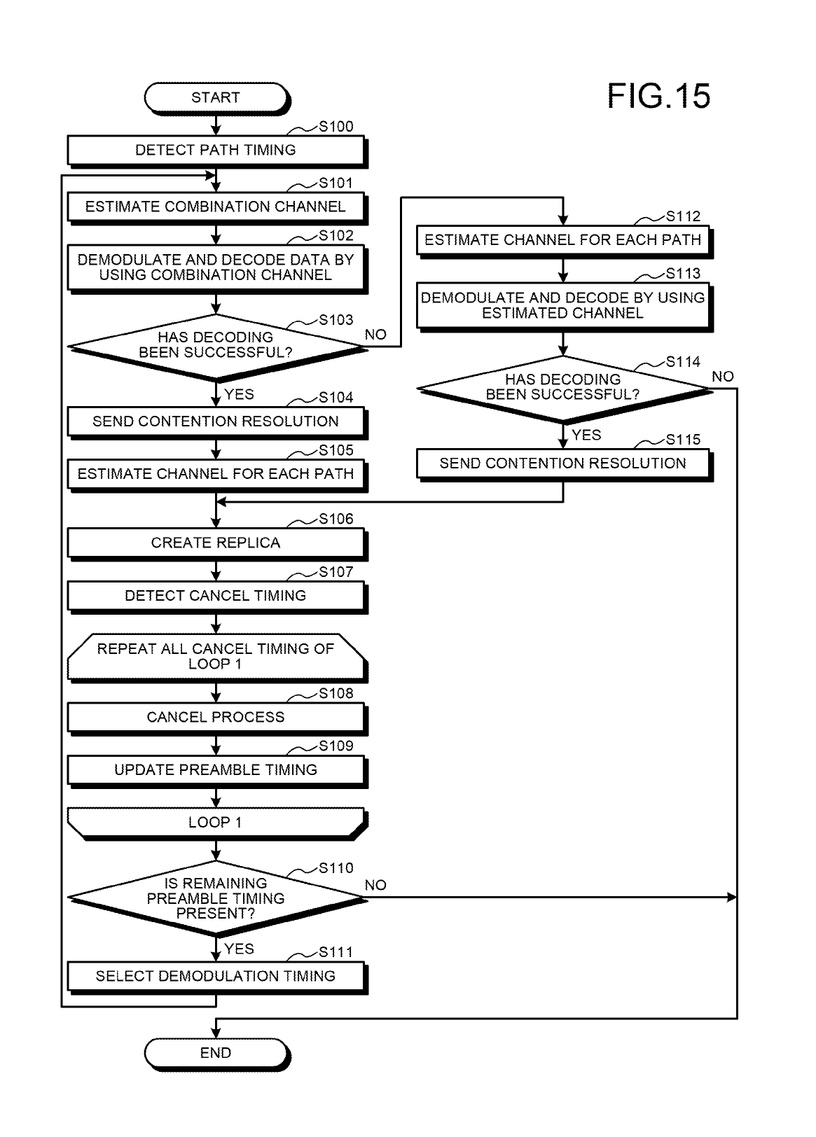

FIG. 15 is a flowchart for an explanation of a process example of the base station according to the first embodiment. The flowchart illustrated in FIG. 15 is started when, for example, the base station 10 receives an RA preamble.

First, the preamble detecting unit 107 detects the PA-ID included in the RA preamble and the path timing of the RA preamble (Step S100). Then, the preamble detecting unit 107 outputs the detected PA-ID to the message processing unit 127 and stores, as the PA timing, the path timing detected for each PA-ID in the preamble timing storing unit 109.

Then, the Msg-3 acquiring unit 111 acquires, in accordance with the UL grant that is input from the message processing unit 127, the Msg 3 that is sent from the UE after the RA preamble has been sent and outputs the acquired Msg 3 to the data storing unit 113. The Msg 3 is stored as the demodulation target data in the data storing unit 113. Then the channel estimating unit 115 estimates a combination channel by using the demodulation target data (Step S101). The channel estimating unit 115 estimates a combination channel obtained by combining the plurality of channels of the paths included in the Msg 3 by using the pilot that is attached to the Msg 3.

Then, in accordance with the demodulation timing instructed from the timing control unit 125, on the basis of the combination channel estimated by the channel estimating unit 115, the demodulation decoding unit 117 demodulates the demodulation target data stored in the data storing unit 113 and decodes the demodulated data (Step S102). Then, by determining whether the CRC has been successful, the demodulation decoding unit 117 determines whether the decoding of the demodulated data has been successful (Step S103).

If the demodulation decoding unit 117 succeeds in decoding the demodulated data (Yes Step S103), the message processing unit 127 creates Contention Resolution. Then, the wireless transmission unit 129 sends the Contention Resolution created by the message processing unit 127 (Step S104).

Then, the separation channel estimating unit 133 acquires the demodulation target data from the data storing unit 113. Then, the separation channel estimating unit 133 specifies Expression (5) described above on the basis of the demodulation target data and the path timing for channel notified from the timing control unit 125. Then, the separation channel estimating unit 133 estimates the channel hᵢ for each of the paths from the demodulation target data on the basis of Expression (5) (Step S105). Then, the separation channel estimating unit 133 outputs the channel hᵢ estimated for each of the paths to the cancelling unit 123.

Then, the replica creating unit 119 creates a replica of the Msg 3 by encoding and modulating the decoded Msg 3 (Step S106). Then, the path timing detecting unit 121 detects the cancel timing (Step S107).

Then, the processes at Steps S108 and S109 are repeatedly performed under the condition of a loop 1. Namely, for all of the pieces of cancel timing detected at Step S107, the processes at Steps S108 and S109 are repeatedly performed.

At Step S108, the cancelling unit 123 creates cancel data by multiplying the channel input from the separation channel estimating unit 133 by the replica created by the replica creating unit 119. Then, the cancelling unit 123 cancels the cancel data from the demodulation target data stored in the data storing unit 113.

Then, at Step S109, the timing control unit 125 updates the PA timing stored in the preamble timing storing unit 109 on the basis of the cancel timing targeted for the cancel performed by the cancelling unit 123. For example, the timing control unit 125 deletes the PA timing associated with the cancel timing targeted for the cancel from the PA timing stored in the preamble timing storing unit 109.

After the end of the repetitive process of the loop 1, the timing control unit 125 determines whether the remaining PA timing is present in the preamble timing storing unit 109 (Step S110). If the remaining PA timing is not present in the preamble timing storing unit 109 (No at Step S110), the process ends.

In contrast, if the remaining PA timing is present in the preamble timing storing unit 109 (Yes at Step S110), the timing control unit 125 performs the following process. Namely, the timing control unit 125 selects the timing of demodulation to be performed by the demodulation decoding unit 117 from among the pieces of the PA timing stored in the preamble timing storing unit 109 (Step S111). For example, if a plurality of pieces of remaining PA timing is present in the preamble timing storing unit 109 after pieces of the PA timing are updated at Step S109, the timing control unit 125 selects the demodulation timing as follows. Namely, the timing control unit 125 selects, as the demodulation timing that is used for the subsequent demodulation, the PA timing with the maximum power from among the plurality of the pieces of PA timing. Then, the timing control unit 125 instructs the selected demodulation timing to the demodulation decoding unit 117. After the process at Step S111, the process returns to Step S101.

Furthermore, if the demodulation decoding unit 117 fails to decode the modulated data (No at Step S103), the separation channel estimating unit 133 acquires the demodulation target data from the data storing unit 113. Then, the separation channel estimating unit 133 specifies Expression (5) described above on the basis of the pilot signal of the demodulation target data and the path timing for each of the channels notified from the timing control unit 125. Then, the separation channel estimating unit 133 estimates the channel hᵢ for each of the paths from the pilot signal of the demodulation target data on the basis of Expression (5) (Step S112). Then, the separation channel estimating unit 133 outputs the channel hᵢ estimated for each of the paths to the demodulation decoding unit 117.

By using the channel hᵢ for each of the paths estimated by the separation channel estimating unit 133, the demodulation decoding unit 117 demodulates the demodulation target data and decodes the demodulated data (Step S113). Then, the demodulation decoding unit 117 determines whether the decoding of the demodulated data has been successful (Step S114). If the demodulation decoding unit 117 succeeds the decoding of the demodulated data (Yes at Step S114), the message processing unit 127 creates Contention Resolution. Then, the wireless transmission unit 129 sends the Contention Resolution created by the message processing unit 127 (Step S115). Then, the process indicated by Step S106 is performed. In contrast, if the demodulation decoding unit 117 fails to decode the demodulated data (No at Step S114), the process ends.

Process Example of the Communication System

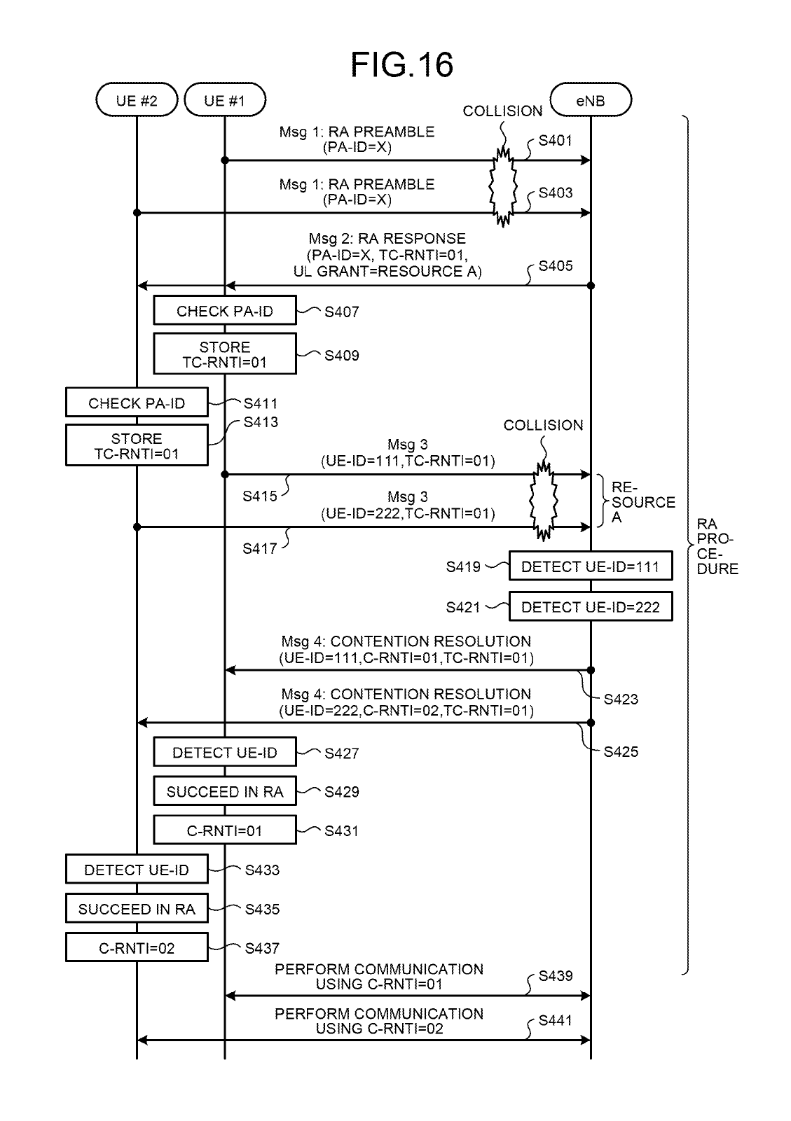

FIG. 16 is a schematic diagram illustrating an example of the processing sequence of the communication system according to the first embodiment. In FIG. 16, an example of the RA procedure in which both the UE #1 and the UE #2 send the same RA preambles by using the same resource is illustrated.

First, the UE #1 randomly selects a single PA-ID out of the plurality of the previously prepared different PA-IDs and sends the RA preamble including the selected PA-ID as the Msg 1 to the eNB (Step S401). At Step S401, it is assumed that the UE #1 selects, for example, the PA-ID=X.

In contrast, the UE #2 randomly selects a single PA-ID out of the plurality of the previously prepared different PA-IDs and sends the RA preamble including the selected PA-ID as the Msg 1 to the eNB (Step S403). At Step S403, it is assumed that the UE #2 selects, for example, the PA-ID=X. Furthermore, at Step S403, it is assumed that the UE #2 sends the RA preamble by using the same resource as that used by the UE #1 to send the RA preamble. Namely, it is assumed that the UE #2 sends the same RA preamble as that sent by the UE #1 by using the same resource as that used by the UE #1.

Thus, in the eNB, the RA preamble received from the UE #1 comes into collision with the RA preamble received from the UE #2 and reception of the two RA preambles is observed as a plurality number of receptions of the same RA preambles.

The eNB that detects the RA preamble including the PA-ID=X sends an RA response with respect to the RA preamble as the Msg 2 (Step S405). Here, the RA response includes the PA-ID that is included in the RA preamble, the TC-RNTI, and the UL grant. The uplink resource indicated by the UL grant is defined by the time and the frequency. For example, the eNB allocates the TC-RNTI=01 and the UL grant=resource A to the PA-ID=X. Consequently, for example, the eNB that detects the RA preamble including the PA-ID=X sends the RA response that includes therein the PA-ID=X, the TC-RNTI=01, and the UL grant=resource A to the Msg 2. Namely, the PA-ID=X, the TC-RNTI=01, and the UL grant=resource A are associated with each other. At Step S405, the RA response sent from the eNB is received by the UE #1 and the UE #2.

The UE #1 that has received the RA response checks whether the PA-ID=X selected at Step S401 is included in the received RA response (Step S407). Because the PA-ID=X is included in the RA response, the UE #1 stores therein the TC-RNTI=01 that is included in the RA response (Step S409).

The UE #2 that has received the RA response checks the PA-ID=X selected at Step S403 is included in the received RA response (Step S411). Because the PA-ID=X is included in the received RA response, the UE #2 stores therein the TC-RNTI=01 that is included in the RA response (Step S413).

Then, because the PA-ID=X is included in the received RA response, the UE #1 sends the Msg 3 to the eNB by using the resource A (Step S415). In the Msg 3 sent from the UE #1, the UE-ID (for example, UE-ID=111) of the UE #1 and the CRC bits masked by the TC-RNTI=01 are included.

Furthermore, because the PA-ID=X is included in the received RA response, the UE #2 sends the Msg 3 to the eNB by using the resource A (Step S417). In the Msg 3 sent from the UE #2, the UE-ID (for example, UE-ID=222) of the UE #2 and the CRC bits masked by the TC-RNTI=01 are included.

At Steps S419 and S421, the eNB attempts to receive the Msg 3 in the resource A that is allocated at Step S405. Because the uplink resource allocated by the eNB is associated with, one to one, the TC-RNTI allocated by the eNB, the eNB decodes the Msg 3 received by using the resource A by using the TC-RNTI=01 associated with the resource A.

At this point, both the Msg 3 sent from the UE #1 and the Msg 3 sent from the UE #2 are sent by using the resource A. Namely, because the Msg 3 from the UE #1 and the Msg 3 from the UE #2 are sent by the same resource, the Msgs 3 reach the eNB in a temporally overlapped manner. Consequently, in the eNB, the Msg 3 sent from the UE #1 comes into collision with the Msg 3 sent from the UE #2. Thus, first, the eNB attempts to demodulate and decode the Msgs 3 by using the combination channel estimated from the reception signal. If the demodulation and decoding of the Msg 3 by using the combination channel has been successful, the eNB cancels the data on the Msg 3, in which the decoding has been successful, from the reception signal and attempts to further demodulate and decode the cancelled reception signal by estimating the combination channel. If the demodulation and decoding of the Msg 3 by using the combination channel has failed, the eNB estimates a channel for each of the paths on the basis of Expression (5) described above. Then, the eNB again attempts to demodulate and decode the reception signal by using the estimated channel for each of the paths.

By performing the process at Steps S100 to S115 illustrated in FIG. 15, the eNB demodulates and decodes the Msg 3 sent from the UE #1 and the Msg 3 sent from the UE #2 that are received by using the resource A. Then, the eNB detects the UE-ID=111 included in the data portion in the Msg 3 sent from the UE #1 (Step S419) and detects the UE-ID=222 included in the data portion in the Msg 3 sent from the UE #2 (Step S421).

The eNB allocates the C-RNTI=01 to the UE-ID=111 that is detected at Step S419. Then, the eNB sends the Contention Resolution that includes therein the UE-ID=111, the C-RNTI=01, and the CRC bits masked by the TC-RNTI=01 (Step S423). Furthermore, the eNB allocates the C-RNTI=02 to the UE-ID=222 detected at Step S421. Then, the eNB sends the Contention Resolution that includes therein the UE-ID=222, the C-RNTI=02, and the CRC bits masked by the TC-RNTI=01 (Step S425).

The UE #1 decodes the received Contention Resolution by using the TC-RNTI=01 that is stored at Step S409. In the Contention Resolution sent from the eNB at Step S423, the UE-ID=111, the C-RNTI=01, and the CRC bits masked by the TC-RNTI=01 are included. Thus, the UE #1 that performs the decoding by using the TC-RNTI=01 succeeds in the decoding of the Contention Resolution that is sent from the eNB at Step S423 and detects the UE-ID=111 that is included in the data portion in the Contention Resolution (Step S427).

Then, the UE #1 determines whether the UE-ID detected at Step S427 is the UE-ID of the own terminal. Because the UE-ID=111 detected at Step S427 is the UE-ID of the UE #1, the UE #1 determines that the RA has been successful (Step S429). Then, the UE #1 acquires the C-RNTI=01 from the Contention Resolution in which the decoding has been successful at Step S427 (Step S431).

In contrast, the UE #2 decodes the received Contention Resolution by using the TC-RNTI=01 that is stored at Step S413. In the Contention Resolution sent from the eNB at Step S425, the UE-ID=222, the C-RNTI=02, and the CRC bits masked by the TC-RNTI=01 are included. Thus, the UE #2 that performs the decoding by using the TC-RNTI=01 succeeds in the decoding of the Contention Resolution that is sent from the eNB at Step S425 and detects the UE-ID=222 that is included in the data portion in the Contention Resolution (Step S433).

Then, the UE #2 determines whether the UE-ID detected at Step S433 is the UE-ID of the own terminal. Because the UE-ID=222 detected at Step S433 is the UE-ID of the UE #2, the UE #2 determines that the RA has been successful (Step S435). Then, the UE #2 acquires the C-RNTI=02 from the Contention Resolution in which the decoding has been successful at Step S433 (Step S437).

The UE #1 that determines that the RA has been successful starts communication between the eNB and the user data by using the C-RNTI=01 acquired at Step S431 (Step S439). Furthermore, the UE #2 that determines that the RA has been successful starts communication between the eNB and the user data by using the C-RNTI=02 acquired at Step S437 (Step S441).

As described above, the base station 10 according to the first embodiment includes the preamble detecting unit 107, the demodulation decoding unit 117, and the separation channel estimating unit 133. The preamble detecting unit 107 detects, from the reception signal received after the RA preamble is received in the RA procedure, the path timing of each of the paths included in the reception signal. The separation channel estimating unit 133 specifies a plurality of relational expressions at different sample points. Each of the relational expressions that represents the reception signal by using the path timing and the channel for each of the paths, as indicated by, for example, Expression (5) described above. The number of the relational expressions corresponds to at least the number of paths. Then, the separation channel estimating unit 133 specifies a channel for each of the paths on the basis of the correlation of the specified relational expressions. The demodulation decoding unit 117 demodulates, for each of the paths, the Msg 3 from the reception signal by using the channel specified by the separation channel estimating unit 133. The Msg 3 is an example of data received after the base station 10 receives the RA preamble in the RA procedure.

By doing so, even if the Msg 3 sent from the UE #1 comes into collision with the Msg 3 sent from the UE #2 caused by both the UE #1 and the UE #2 sending the same RA preamble by using the same resource, the eNB can estimate, with high accuracy, a channel of a path for the signal sent from each of the UEs. Consequently, even if the Msg 3 sent from the UE #1 comes into collision with the Msg 3 sent from the UE #2, the eNB can succeed in decoding both the Msg 3 sent from the UE #1 and the Msg 3 sent from the UE #2. Thus, the eNB can separately send Contention Resolution that includes therein unique information to the UE #1 and the UE #2. Thus, according to the first embodiment, it is possible to improve the success rate of the RA.

Furthermore, the separation channel estimating unit 133 specifies the relational expressions at different sample points in the time domain. Each of the relational expressions represents the reception signal in the time domain by using the path timing for each of the paths, the channel for each of the paths, and a replica of the reference signal included in the reception signal. The number of the relational expressions corresponds to at least the number of paths. Then, the separation channel estimating unit 133 specifies the channels for each of the paths that satisfy the specified relational expressions. By doing so, even if the Msg 3 sent from the UE #1 comes into collision with the Msg 3 sent from the UE #2, the eNB can estimate, with high accuracy, a channel for each of the paths for the signal sent from each of the UEs due to computation in the time domain.

Furthermore, the separation channel estimating unit 133 specifies the relational expressions included in Expression (5) described above for each of the different time periods. The separation channel estimating unit 133 specifies the relational expressions by using both a signal that is obtained by adding the reception signals at a predetermined number of sample points included in the time periods and a signal that is obtained by adding the reception signals each of which is represented by using the path timing for each of the paths, the channel for each of the paths, and the replica of the reference signal, which are at a predetermined number of sample points included in the time periods. By doing so, the eNB can reduce the effect of the noise when the eNB estimates the channel of each of the paths of the signal that is sent from each of the UEs and the eNB can more accurately estimate the channel of each of the paths.

### [b] Second Embodiment

The eNB according to the first embodiment described above estimates a channel of each of the paths by the process in the time domain. In contrast, the eNB according to a second embodiment estimates a channel of each of the paths by a process in the frequency domain. The functional blocks in the eNB according to the second embodiment are the same as those described in the first embodiment with reference to FIG. 4 except for the following points described below; therefore, overlapped descriptions thereof will be omitted.

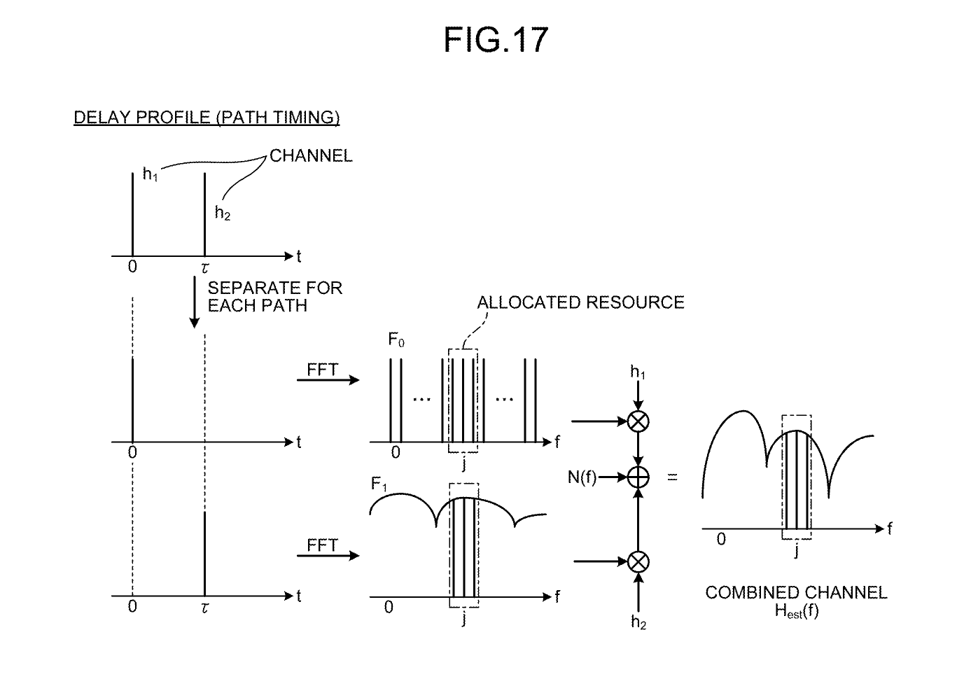

FIG. 17 is a schematic diagram exemplifying a model of a reception signal in the frequency domain. In FIG. 17, it is assumed a case in which the Msg 3 sent from the UE #1 comes into collision with the Msg 3 sent from the UE #2 caused by both the UE #1 and the UE #2 sending the same RA preamble by using the same resource. For example, it is assumed that the path 1 with the delay time of 0 and the path 2 with the delay time of τ are detected at the predetermined timing as a reference. It is assumed that the path 1 is the path through which the Msg 3 from the UE #1 is sent and the path 2 is the path through which the Msg 3 from the UE #2 is sent. It is conceivable that the signal received by the eNB is the signal obtained by performing a Fast Fourier Transform (FFT) on the delay profile that serves as an amplitude 1 at each path timing, multiplying the channel hᵢ for each of the paths by the signal subjected to the Fast Fourier Transform, adding noise to each of the signals, and combining the signals. The combination channel that is estimated from the signals received by the eNB and that is in the frequency domain is defined as a combination channel estimated value Hₑₛₜ(f).

In the second embodiment, the separation channel estimating unit 133 in the eNB creates a delay profile corresponding to the amplitude 1 at each of the pieces of the path timing. Each of the pieces of the path timing is detected by the preamble detecting unit 107 in the eNB. Then, by performing the Fast Fourier transform on the delay profile of each of the pieces of the path timing, the separation channel estimating unit 133 transforms the signal to the frequency domain data (F₀ and F₁ in FIG. 17). Here, for example, it is assumed that the subcarrier enclosed by the broken line illustrated in FIG. 17 is the resource for the uplink allocated to each of the UEs. The separation channel estimating unit 133 calculates a combination channel estimated value Hₑₛₜ(f) by multiplying the channel hᵢ of each of the paths by the subcarrier in the frequency resource allocated to the UE, by adding noise N(f), and combining the channels. Furthermore, the separation channel estimating unit 133 calculates a combination channel estimated value Hₑₛₜ(f) by performing Fast Fourier transform on the reception signal. Then, the separation channel estimating unit 133 specifies, for example, Expression (6) below:

$${\sum }_{f = {f}_{1}}^{{f}_{2}} {H}_{est} ( f ) = {\sum }_{f = {f}_{1}}^{{f}_{2}} {\sum }_{i = 0}^{1} {h}_{i} \times {F}_{i} ( f ) + N ( f ) ≅ {\sum }_{f = {f}_{1}}^{{f}_{2}} {\sum }_{i = 0}^{1} {h}_{i} \times FFT [ δ ( t - {τ}_{i} ) ] \\ {\sum }_{f = {f}_{3}}^{{f}_{4}} {H}_{est} ( f ) = {\sum }_{f = {f}_{3}}^{{f}_{4}} {\sum }_{i = 0}^{1} {h}_{i} \times {F}_{i} ( f ) + N ( f ) ≅ {\sum }_{f = {f}_{3}}^{{f}_{4}} {\sum }_{i = 0}^{1} {h}_{i} \times FFT [ δ ( t - {τ}_{i} ) ] \qquad ( 6 )$$

where, the elements represented by Expression (6) above are those represented by Expression (7) below. Furthermore, FFT[x] represents the result of the Fast Fourier transform of x.

$${F}_{i} ( f ) = FFT [ δ ( t - {τ}_{i} ) ] \\ δ ( t - {τ}_{i} ) = \{ \begin{matrix}1 & if ( t = {τ}_{i} ) \\ 0 & if ( t \neq {τ}_{i} )\end{matrix} \\ N ( f ) = FFT [ n ( t ) ] \qquad ( 7 )$$

Expression (6) above is simultaneous equations in which h₀ and h₁ that are the channels of each of the two paths are variables. Furthermore, in Expression (6) above, the plurality of relational expressions each represents the signal converted from the reception signal by using the path timing τᵢ and the channel hᵢ for each of the paths. Furthermore, in Expression (6) above, the relational expressions the number of which corresponds to at least the number of paths used for obtaining a channel are included. In Expression (6) above, because the number of paths used for obtaining a channel is two, the two relational expressions are included. Furthermore, if the relational expressions the number of which is equal to or greater than the number of paths used for obtaining a channel is included, in Expression (6) above, three or more relational expressions may also be included.

Furthermore, in each of the relational expressions included in Expression (6) above, the combination channel estimated value Hₑₛₜ(f) that indicates the frequency characteristic of the reception signal is represented by using a first signal that is the sum of signals each obtained by multiplying FFT[δ(t−τᵢ)], which is the signal in which a delay profile is converted to the frequency domain for each of the paths, by the channel hᵢ of each of the paths. Furthermore, each of the relational expressions included in Expression (6) above is the relational expression specified by using some subcarriers that are allocated as the uplink resource. The subcarriers allocated as the resource for the Msg 3 by the UL grant are an example of the sample points with different frequencies in the frequency domain.

In this way, the separation channel estimating unit 133 according to the second embodiment specifies the relational expressions at different sample points with different frequencies in frequency domain. Each of the relational expressions represents the combination channel, which indicates the frequency characteristic of the reception signal, by using the sum of the signals each obtained by multiplying the signal, in which a delay profile is converted to the frequency domain for each of the paths, by the channel for each of the paths. The number of relational expressions corresponds to at least the number of paths. Then, the separation channel estimating unit 133 specifies the channels for each of the paths that satisfy the specified relational expressions. By doing so, even if the Msg 3 sent from the UE #1 comes into collision with the Msg 3 sent from the UE #2, the eNB can estimate, with high accuracy, a channel for each of the paths for the signal sent from each of the UEs due to computation in the frequency domain.

Furthermore, in Expression (6) above, the relational expressions are specified for different frequency bands such as the frequency band from the frequency f₁ to f₂ and the frequency band from the frequency f₃ to f₄. The left side of Expression (6) above represents the signal obtained by adding a value of the combination channel estimated value of frequency at a predetermined number of sample points in a frequency band. Furthermore, the right side of Expression (6) above represents the signal obtained by adding a value of the first signal with the frequency at the predetermined number of sample points in the frequency band. By doing so, the eNB can reduce the effect of noise when the channel of each path of the signal sent from each of the UEs and can more accurately estimate the channel of each path. Furthermore, each of the relational expressions included in Expression (6) above may also be averaged by dividing the left side and the right side of Expression (6) by the number of sample points. Furthermore, the sample points in the frequency band used for each of the relational expressions, i.e., subcarriers, do not need to be adjacent subcarriers. Furthermore, the frequency band in which the subcarriers that are used for each of the relational expressions may also be overlapped with each other or may also be separated.

### [c] Another Embodiment

[1] In the first embodiment described above, the separation channel estimating unit 133 reduces the effect of noise when a channel is estimated by adding or averaging the value of the relational expressions at a predetermined number of sample points in the time period for each of the pieces of different time period; however, the disclosed technology is not limited to this. For example, the separation channel estimating unit 133 may also estimate a channel for each of the paths by specifying a relational expression one by one for each sample point; performing, for several times, a process of estimating a channel for each of the paths from the specified relational expression; and averaging, for each path, the plurality of the estimated channels.

For example, in Expression (4) above, if, for example, the values of pieces of the time t₁ and t₂ are used as the sample points, Expression (8) below is obtained.

$$y ( {t}_{1} ) = {\sum }_{i} {h}_{i} \times {DMRS}_{replica} ( {t}_{1} - {τ}_{i} ) + n ( {t}_{1} ) \\ y ( {t}_{2} ) = {\sum }_{i} {h}_{i} \times {DMRS}_{replica} ( {t}_{2} - {τ}_{i} ) + n ( {t}_{2} ) \qquad ( 8 )$$

In Expression (8), the reception signal y (t), the replica DMRS_{replica}(t) of a pilot signal, and the delay time τᵢ of a path are already known. Thus, by solving the simultaneous equations represented by Expression (8) above, the channels h₁ and h₂ of each of the paths can be estimated. However, because the pieces of the noise n(t₁) and n(t₂) are unknown, the noise is defined as 0. Consequently, an error is included in the channels h₁ and h₂ of each of the paths calculated from Expression (8) above, which result in a value that is deviated from an ideal value.

Similarly, in Expression (4) above, if, for example, the values of pieces of the time t₃ and t₄ that are different from the time t₁ and t₂ are used as the sample points, following Expression (9) below is obtained.

$$y ( {t}_{3} ) = {\sum }_{i} {h}_{i} \times {DMRS}_{replica} ( {t}_{3} - {τ}_{i} ) + n ( {t}_{3} ) \\ y ( {t}_{4} ) = {\sum }_{i} {h}_{i} \times {DMRS}_{replica} ( {t}_{4} - {τ}_{i} ) + n ( {t}_{4} ) \qquad ( 9 )$$

By solving the simultaneous equations represented by Expression (9) above, the channels h₁ and h₂ of each of the paths can be estimated. However, the pieces of the noise n(t₃) and n(t₄) are value different from the values of the pieces of the noise n(t₁) and n(t₂) represented by Expression (8) above. Thus, the values of the channels h₁ and h₂ of each of the paths calculated from Expression (9) above become the values different from the values of the channels h₁ and h₂ of each of the paths calculated from Expression (8) above.

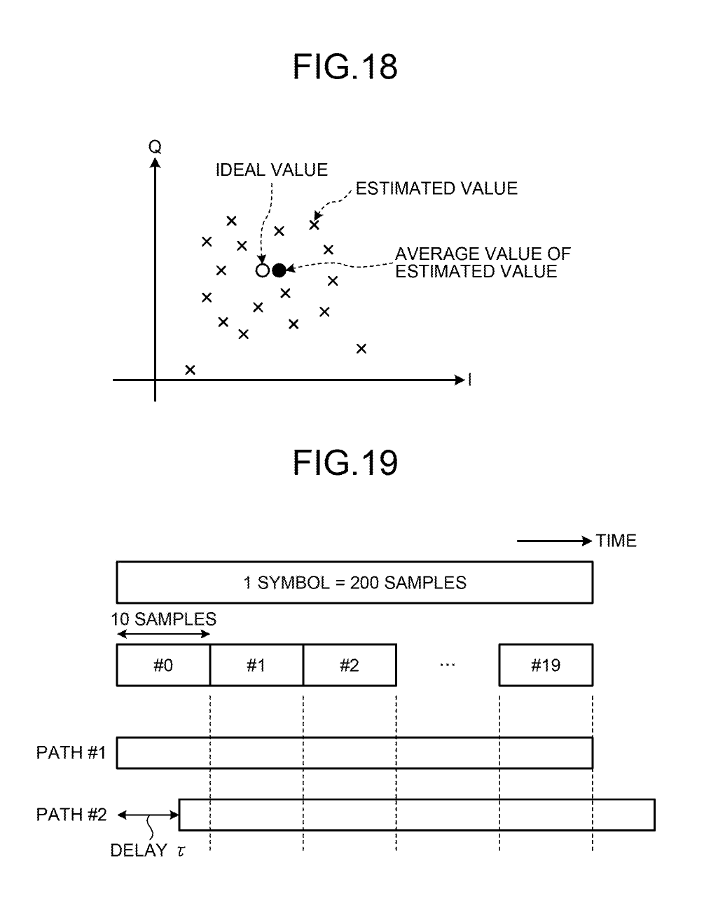

In this way, if a channel of each of the paths is estimated from different sample points, the value of the estimated channel is obtained, as, for example, illustrated in FIG. 18, as a plurality of solutions (x illustrated in FIG. 18) centered on the ideal value (the white dot ∘ illustrated in FIG. 18) due to the effect of different noise. FIG. 18 is a schematic diagram used for an explanation of another example of channel estimation. Each of the values illustrated in FIG. 18 indicates the ideal values and the estimated value of the channels on the complex plane. Because the average value of the white noise is 0, by calculating the average value (the black dot illustrated in FIG. 18) of the plurality of estimated solutions, it is possible to cancel out the effect of the noise and improve the accuracy of estimating the channel of each of the paths.

[2] In the first embodiment described above, the time period in which the plurality of the samples are included is divided into time periods with a predetermined length and the effect of the noise at the time of estimating the channel of each of the paths by adding the relational expression for each divided time period by the number of samples in the respective divided time period; however, the disclosed technology is not limited to this. For example, it is also possible to estimate the channel of each of the paths by estimating the channel of each of the paths by using a combination of different divided time periods and by averaging the plurality of channels estimated for each path.

For example, it is assumed that the pilot signal with one symbol is constituted by 200 samples. If the number of samples in Expression (5) above is 10 consecutive samples, the signal with 1 symbol is, for example, as illustrated in FIG. 19, divided into 20 blocks with 10 samples from the top timing of the received symbol. FIG. 19 is a schematic diagram used for an explanation of another example of channel estimation. Furthermore, FIG. 19 illustrates a case in which the samples selected between blocks are not overlapped.

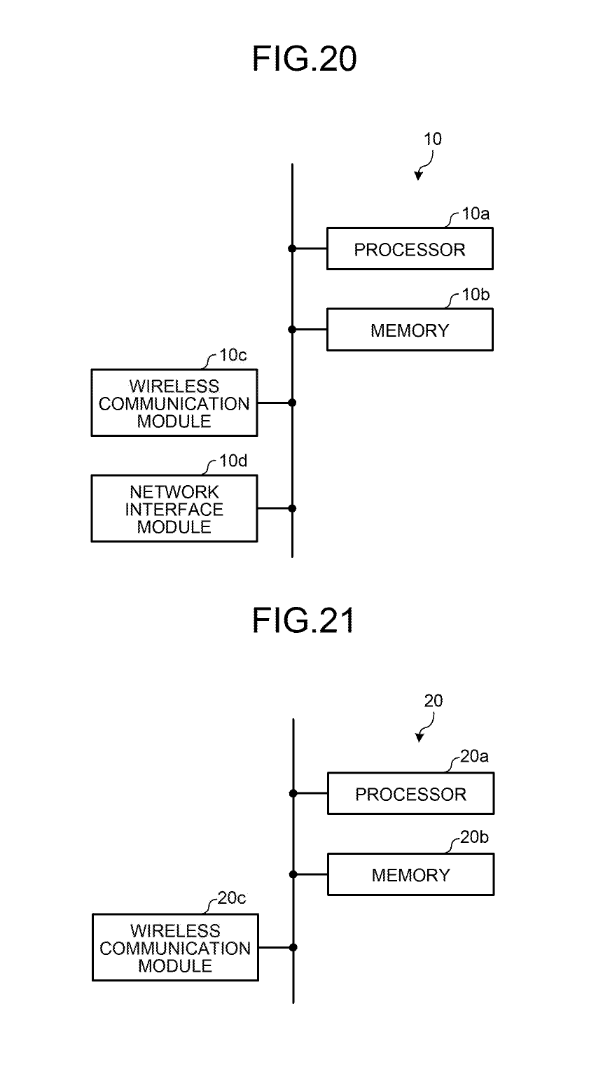

If two paths each having the direct wave and the delay wave with the delay of τ are detected, the top block #0 is excluded because interference with the immediately previous symbol occurs. Then, by selecting arbitrary two blocks from among the remaining 19 blocks and performing an addition process in the blocks, the separation channel estimating unit 133 can create the simultaneous equations represented by Expression (5). Furthermore, because the number of combinations of extracting arbitrary two blocks from among the remaining 19 blocks is present ₁₉C₂=171, the accuracy of estimating the channel can be further improved by averaging the values of the channels of each of the paths estimated for 171 combinations.

[3] Expression (5) that represents the process in the time domain and Expression (6) that represents the process in the frequency domain have the following relationship. Namely, the reception signal y (t) represented in Expression (5) is associated with the combination channel estimated value Hₑₛₜ(f) represented in Expression (6). Furthermore, the replica DMRS_{replica}(t−τᵢ) of the pilot signal represented in Expression (5) is associated with the path delay profile FFT [δ(t−τᵢ)] represented in Expression (6). Then, the target segment is, in Expression (5) that represents the process in the time domain, the sample points in the symbol of the pilot signal and is, in Expression (6) that represents the process in the frequency domain, the subcarriers of the allocated frequency resource. Thus, Expression (5) and Expression (6) are equivalent expressions. Accordingly, the method described in [1] for performing several times the estimating process that estimates the channels of two paths from the two relational expressions that is used to specify two sample points, on a pair with different sample points can also be used for Expression (6) that represents the process in the frequency domain. Furthermore, the method that estimates the channel of each path described in [2] by estimating the channel of each of the paths by using a combination of different divided time periods and by averaging the plurality of channels estimated for each of the paths, can also be used for Expression (6) that represents the process in the frequency domain.

[4] The base station 10 can be implemented by, for example, the hardware configuration as follows. FIG. 20 is a schematic diagram illustrating an example of the hardware configuration of the base station. As illustrated in FIG. 20, the base station 10 includes, as a hardware component, a processor 10a, a memory 10b, a wireless communication module 10c, and a network interface module 10d. An example of the processor 10a includes a central processing unit (CPU), a digital signal processor (DSP), a field programmable gate array (FPGA), or the like. Furthermore, the base station 10 may also include a Large Scale Integrated (LSI) circuit that includes therein the processor 10a and a peripheral circuit. An example of the memory 10b includes a RAM, such as a synchronous dynamic random access memory (SDRAM) and the like, a read only memory (ROM), a flash memory, or the like.

The antenna 101, the wireless receiving unit 103, and the wireless transmission unit 129 are implemented by the wireless communication module 10c. The preamble acquiring unit 105, the preamble detecting unit 107, the Msg-3 acquiring unit 111, the channel estimating unit 115, the demodulation decoding unit 117, and the replica creating unit 119 are implemented by the processor 10a. Furthermore, the path timing detecting unit 121, the cancelling unit 123, the timing control unit 125, the message processing unit 127, the communication processing unit 131, and the separation channel estimating unit 133 are implemented by the processor 10a. The preamble timing storing unit 109 and the data storing unit 113 are implemented by the memory 10b.

[5] The user terminal 20 can be implemented by, for example, the hardware configuration as follows. FIG. 21 is a schematic diagram illustrating an example of the hardware configuration of the user terminal. As illustrated in FIG. 21, the user terminal 20 includes, as a hardware component, a processor 20a, a memory 20b, and a wireless communication module 20c. An example of the processor 20a includes a CPU, DSP, an FPGA, or the like. Furthermore, the user terminal 20 may also include an LSI circuit that includes therein the processor 20a and a peripheral circuit. An example of the memory 20b includes a RAM, such as an SDRAM and the like, a ROM, a flash memory, or the like.

The antenna 207, the wireless transmission unit 205, and the wireless receiving unit 209 are implemented by the wireless communication module 20c. The preamble processing unit 201, the message processing unit 203, the RA control unit 211, and the communication processing unit 213 are implemented by the processor 20a.

According to an aspect of an embodiment of the disclosed technology, the success rate of an RA can be improved.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A base station comprising:
a detecting unit that detects path timing for each path included in a reception signal that is received after a random access preamble is received in a random access procedure;
a specifying unit that specifies a plurality of relational expressions at different sample points, each of the relational expressions representing the reception signal by using the path timing and a channel for each of the paths, number of the relational expressions corresponding to at least number of the paths, and that specifies the channel for each of the paths based on correlation between the specified relational expressions; and
a demodulating unit that demodulates, for each of the paths, data included in the reception signal by using the channel specified by the specifying unit.

2. The base station according to claim 1, wherein
the specifying unit specifies the relational expressions at different sample points in time domain, each of the relational expressions representing the reception signal in the time domain by using the path timing for each of the paths, the channel for each of the paths, and a replica of the reference signal that is included in the reception signal, the number of the relational expressions corresponding to at least number of the paths, and specifies the channels for each of the paths that satisfy the specified relational expressions.

3. The base station according to claim 2, wherein
the specifying unit specifies the relational expressions for each of a plurality of different time periods and specifies, in each of the time periods, the relational expressions by using both a signal that is obtained by adding the reception signals at a predetermined number of sample points included in the time periods and a signal that is obtained by adding the reception signals each of which is represented by using the path timing for each of the paths, the channel for each of the paths, and the replica of the reference signal, which are at the predetermined number of sample points included in the time periods.

4. The base station according to claim 2, wherein
the specifying unit specifies the relational expressions, each of the relational expressions specified for each of a plurality of different time periods or specified from the different sample points, the number of the relational expressions being greater than the number of the paths, specifies the channels for each of the paths that satisfy the relational expressions that are selected by the number of the relational expressions corresponding to the number of the paths, and specifies the channel for each of the paths by averaging the specified channels that satisfy the selected relational expressions.

5. The base station according to claim 1, wherein
the specifying unit specifies the relational expressions at different sample points with different frequencies in frequency domain, each of the relational expressions representing a combination channel, which indicates a frequency characteristic of the reception signal, by using a first signal that is the sum of signals each obtained by multiplying a signal in which a delay profile is converted to the frequency domain for each of the paths by the channel for each of the paths, the number of the relational expressions corresponding to at least the number of the paths, and specifies the channels for each of the paths that satisfy the specified relational expressions.

6. The base station according to claim 5, wherein
the specifying unit specifies the relational expressions for each of a plurality of different frequency bands and specifies, in each of the frequency bands, the relational expressions by using both a signal that is obtained by adding values of the combination channels at a predetermined number of sample points with frequencies in the frequency bands and a signal that is obtained by adding values of the first signal at the predetermined number of sample points with frequencies included in the frequency bands.

7. The base station according to claim 5, wherein
the specifying unit specifies the relational expressions, each of the relational expressions specified for each of a plurality of different frequency bands or specified from the different sample points with different frequencies in the frequency domain, the number of the relational expressions being greater than the number of the paths, specifies the channels for each of the paths that satisfy the relational expressions that are selected by the number of the relational expressions corresponding to the number of the paths, and specifies the channel for each of the paths by averaging the specified channels that satisfy the selected relational expressions.

8. A communication system comprising:
a base station;
a first communication terminal; and
a second communication terminal, wherein
the base station includes
a detecting unit that detects path timing for each path included in a reception signal that is received from the first communication terminal and the second communication terminal after a random access preamble is received in a random access procedure,
a specifying unit that specifies a plurality of relational expressions at different sample points, each of the relational expressions representing the reception signal by using the path timing and a channel for each of the paths, number of the relational expressions corresponding to at least the number of the paths, and that specifies the channel for each of the paths based on correlation between the specified relational expressions, and
a demodulating unit that demodulates, from the reception signal, data received from the first communication terminal and data received from the second communication terminal by demodulating, for each of the paths, the reception signal by using the channel specified by the specifying unit.

9. A processing method performed by a base station, the processing method comprising:
detecting path timing for each path included in a reception signal that is received after a random access preamble is received in a random access procedure;
specifying a plurality of relational expressions at different sample points, each of the relational expressions representing the reception signal by using the path timing and a channel for each of the paths, number of the relational expressions corresponding to at least number of the paths, and specifying the channel for each of the paths based on correlation between the specified relational expressions; and
demodulating, for each of the paths, data included in the reception signal by using the specified channel.
